(19) United States
(12) Patent Application Publication
(10) Pub. No.: US 2026/0167526 A1
(43) Pub. Date: Jun. 18, 2026

(54) WATER PURIFIER AND SPLIT-TYPE UV STERILIZATION MODULE

(71) Applicants: JIANGSU KINGCLEAN INTELLIGENT APPLIANCE CO., LTD., Suzhou (CN); KINGCLEAN ELECTRIC GREEN TECHNOLOGY (SUZHOU) CO., LTD., Suzhou (CN); KINGCLEAN ELECTRIC CO., LTD., Suzhou (CN)

(72) Inventors: Lei ZHANG, Suzhou (CN); Xueyu WANG, Suzhou (CN); Yu ZHOU, Suzhou (CN)

(73) Assignees: JIANGSU KINGCLEAN INTELLIGENT APPLIANCE CO., LTD., Suzhou (CN); KINGCLEAN ELECTRIC GREEN TECHNOLOGY (SUZHOU) CO., LTD., Suzhou (CN); KINGCLEAN ELECTRIC CO., LTD., Suzhou (CN)

(21) Appl. No.: 19/536,194

(22) Filed: Feb. 10, 2026

Related U.S. Application Data
(63) Continuation of application No. PCT/CN2024/119672, filed on Sep. 19, 2024.

(30) Foreign Application Priority Data
Aug. 31, 2023 (CN) 202322356914.9
Sep. 20, 2023 (CN) 202311216005.3
Sep. 20, 2023 (CN) 202311216117.9
Sep. 20, 2023 (CN) 202322556286.9

(51) Int. Cl. C02F 1/32; C02F 1/00; C02F 1/44; C02F 9/20

(52) U.S. Cl. CPC C02F 1/32; C02F 1/003; C02F 1/325; C02F 1/444; C02F 9/20; C02F 2209/42

(57) ABSTRACT

Disclosed is a water purifier. A purified water tank is detachably disposed on an outer side of a housing. A bottom wall of a first mounting groove is provided with a first mounting port. A lamp cover is located in the first mounting groove, and a head of the lamp cover is exposed into the purified water tank through the first mounting port. A first locating member sleeves an outer peripheral side of the lamp cover. At least one first sealing ring is sealingly disposed between a first locating member and the first mounting groove. At least one second sealing ring is sealingly disposed between the first locating member and the lamp cover. A sterilization lamp is disposed on an outer wall of the housing, and extends into an inner side of the lamp cover when the purified water tank is disposed on the outer side of the housing.

### CROSS-REFERENCE TO RELATED APPLICATIONS

This application is a continuation of PCT Application No. PCT/CN2024/119672, filed on Sep. 19, 2024, which claims priority to Chinese Patent Application No. 202311216005.3, filed on Sep. 20, 2023, Chinese Patent Application No. 202311216117.9, filed on Sep. 20, 2023, Chinese Patent Application No. 202322356914.9, filed on Aug. 31, 2023, and Chinese Patent Application No. 202322556286.9, filed on Sep. 20, 2023, the contents of which are hereby incorporated by reference.

### TECHNICAL FIELD

The present disclosure generally relates to the field of water purification technology, in particular to a water purifier and a UV sterilization module.

### BACKGROUND

With the improvement of people's living standards, an increasing number of people are pursuing a high-quality lifestyle, and water purifiers are undoubtedly among the top choices. In the water purifiers with external purified water tanks available in the relevant technologies, sterilization components are mostly mounted on the tanks to sterilize the stored water inside. To facilitate the power supply for these sterilization components, they are usually installed through the tank walls, with their sterilizing light exit ends located inside the tanks and their terminals exposed outside the tanks. Although sealing elements such as gaskets are generally installed between the sterilization components and the tank walls for sealing purposes, these sealing elements tend to age over time, which may lead to water leakage at the installation positions of the sterilization components.

A purified water tank is generally arranged inside a water purifier or a water purifying dispenser, which is used for storing purified water processed through purification. The purified water tank is not of a fully sealed structure; a tank cover is usually mounted on its top. Consequently, it is difficult to completely isolate the purified water inside the tank from the air. Bacteria tend to breed in the purified water tank during long-term use, posing a threat to water consumption safety. For sterilization purposes, the conventional method is to suspend a UV lamp module into the purified water tank from the tank cover via a tube or a rope to sterilize the water. This method has the following drawbacks: the tube or rope used to suspend the module into the tank may obstruct the tank cover, resulting in an incomplete seal; besides, excessive and lengthy tubes or wires appear messy and unsightly. In this context, the applicant is committed to developing a split-type UV sterilization module, which can avoid affecting the closure of the tank cover on the purified water tank while maintaining the aesthetic appearance of the tank.

### SUMMARY

Accordingly, it is desirable to provide a water purifier including a sterilization assembly with high sealing reliability. The embodiments of the present disclosure provide a water purifier.

The water purifier includes a housing.

The water purifier includes a purified water tank detachably disposed on an outer side of the housing. The purified water tank is provided with a purified water tank communication port and a first mounting groove. The purified water tank communication port is configured to communicate with a purified water supply interface of the water purifier. A bottom wall of the first mounting groove is provided with a first mounting port.

The water purifier includes a sterilization unit. The sterilization unit includes a lamp cover, a lamp cover locating assembly, and a sterilization lamp. The lamp cover locating assembly includes a first locating member, which is annular in shape, one or more first sealing rings, and one or more second sealing rings. The lamp cover is located in the first mounting groove, and a head of the lamp cover is exposed into the purified water tank through the first mounting port. The first locating member sleeves an outer peripheral side of the lamp cover. The one or more first sealing rings are sealingly disposed between the first locating member and a side groove wall of the first mounting groove. The one or more second sealing rings are sealingly disposed between the first locating member and the outer peripheral side of the lamp cover.

The sterilization lamp is disposed on an outer wall of the housing, and when the purified water tank is mounted on the outer side of the housing, the sterilization lamp extends into an inner side of the lamp cover.

The objective of the present disclosure is to achieve the effect of not affecting mounting of the water tank cover on the purified water tank and not affecting the aesthetic appearance of the purified water tank.

In order to achieve the objective, the present disclosure adopts the following technical solution.

The embodiments of the present disclosure provide a split-type UV sterilization module. The split-type UV sterilization module includes a lamp cover module and a sterilization module. The lamp cover module includes a fixing ring, a transparent outer cover, a bottom cover, a first sealing ring and a second sealing ring. The fixing ring sleeves an outer side surface of the transparent outer cover, the bottom cover is disposed on a lower end between the fixing ring and the transparent outer cover. The first sealing ring is fixedly disposed between the fixing ring and the transparent outer cover, and the second sealing ring is located on an outer side surface of the fixing ring.

The sterilization module includes a UV lamp and a fixing base, the UV lamp is fixedly disposed on the fixing base and the UV lamp extends into an interior of the transparent outer cover.

### BRIEF DESCRIPTION OF THE DRAWINGS

FIG. 1 is a schematic diagram illustrating a structure of a water purifier according to some embodiments of the present disclosure;

FIG. 2 is a cross-sectional view of a purified water tank of a water purifier according to some embodiments of the present disclosure;

FIG. 3 is a cross-sectional view of a purified water tank of a water purifier from another perspective according to some embodiments of the present disclosure;

FIG. 4 is a partial enlarged view of a region X in FIG. 3;

FIG. 5 is a schematic diagram illustrating an exploded structure of a sterilization unit of a water purifier according to some embodiments of the present disclosure;

FIG. 6 is a cross-sectional view illustrating another structure of a purified water tank of a water purifier according to some embodiments of the present disclosure;

FIG. 7 is a cross-sectional view illustrating another structure of a purified water tank of a water purifier from another perspective according to some embodiments of the present disclosure;

FIG. 8 is a partial enlarged view of a region Y in FIG. 7

FIG. 9 is a schematic diagram illustrating an exploded structure of a water purifier according to some embodiments of the present disclosure;

FIG. 10 is a schematic diagram illustrating an exploded structure of a water purifier from another perspective according to some embodiments of the present disclosure;

FIG. 11 is a cross-sectional view of a liquid level box of a water purifier according to some embodiments of the present disclosure;

FIG. 12 is a schematic diagram illustrating another structure of a communicating vessel of a water purifier according to some embodiments of the present disclosure

FIG. 13 is a cross-sectional view of a liquid level box of a water purifier from another perspective according to some embodiments of the present disclosure;

FIG. 14 is a schematic diagram illustrating a structure of a filter of a water purifier according to some embodiments of the present disclosure;

FIG. 15 is a schematic cross-sectional view of a water purifier according to some embodiments of the present disclosure;

FIG. 16 is a schematic diagram illustrating a structure of a first communication port being mated with a purified water tank communication port of a water purifier according to some embodiments of the present disclosure;

FIG. 17 is a schematic diagram illustrating a cross-sectional structure of a first communication port being separated from a purified water tank communication port of a water purifier according to some embodiments of the present disclosure;

FIG. 18 is a partial enlarged view of a region U in FIG. 17;

FIG. 19 is a schematic diagram illustrating a cross-sectional structure of a first communication port being mated with a purified water tank communication port of a water purifier according to some embodiments of the present disclosure;

FIG. 20 is a partial enlarged view of a region V in FIG. 19;

FIG. 21 is a schematic diagram illustrating a structure of a sealing ring being mated with a communicating vessel connection tube of a water purifier according to some embodiments of the present disclosure;

FIG. 22 is a schematic diagram illustrating a structure of a supporting member being connected to a housing of a water purifier according to some embodiments of the present disclosure;

FIG. 23 is a schematic diagram illustrating a structure of a water vapor separator according to some embodiments of the present disclosure;

FIG. 24a is a schematic diagram illustrating a cross-sectional structure of a water vapor separator according to some embodiments of the present disclosure;

FIG. 24b is a schematic diagram illustrating a structure of a water purifier from another perspective according to some embodiments of the present disclosure;

FIG. 25 is a partial enlarged view of a region Z in FIG. 24a;

FIG. 26 is a schematic diagram illustrating a structure of a water vapor separator from another perspective according to some embodiments of the present disclosure;

FIG. 27 is a partial cross-sectional view of a water vapor separator according to some embodiments of the present disclosure;

FIG. 28 is a cross-sectional view of a water vapor separator from another perspective according to some embodiments of the present disclosure;

FIG. 29 is a schematic diagram illustrating an overall structure of a split-type UV sterilization module according to some embodiments of the present disclosure;

FIG. 30 is a cross-sectional view illustrating an overall structure of a split-type UV sterilization module according to some embodiments of the present disclosure;

FIG. 31 is a schematic diagram illustrating structures of a fixing ring, an outer cover, and a bottom cover of a split-type UV sterilization module according to some embodiments of the present disclosure;

### DETAILED DESCRIPTION

To make the above objectives, features, and advantages of the present disclosure more apparent and easier to understand, the detailed description of the specific embodiments of the present disclosure is provided below with reference to the accompanying drawings. Many specific details are set forth in the following description to facilitate a full understanding of the present disclosure. However, the present disclosure may be implemented in many other ways different from those described herein. Persons skilled in the art may make similar improvements without departing from the spirit of the present disclosure. Therefore, the present disclosure is not limited by the specific embodiments disclosed below. In the description of the present disclosure, the terms “first” and “second” are used for descriptive purposes only and are not to be construed as indicating or implying relative importance or implicitly indicating the quantity of the indicated technical features. Thus, features defined with “first” and “second” may explicitly or implicitly include at least one such feature. In the description of the present disclosure, the meaning of “a plurality of” is at least two, e.g., two, three, etc., unless explicitly and specifically defined otherwise. In the present disclosure, unless otherwise explicitly specified and defined, terms such as “mount”, “connect”, “couple”, and “fix” should be interpreted broadly. For example, a connection may be a fixed connection, a detachable connection, or an integral connection. A connection may be a mechanical connection, an electrical connection, or a direct connection. A connection may be an indirect connection through an intermediate medium, or an internal communication between two elements or an interaction relationship between two elements, unless explicitly defined otherwise. Those skilled in the art may understand the specific meanings of the above terms in the present disclosure according to specific situations.

A water purifier 100 according to some embodiments of the present disclosure is described below with reference to the accompanying drawings.

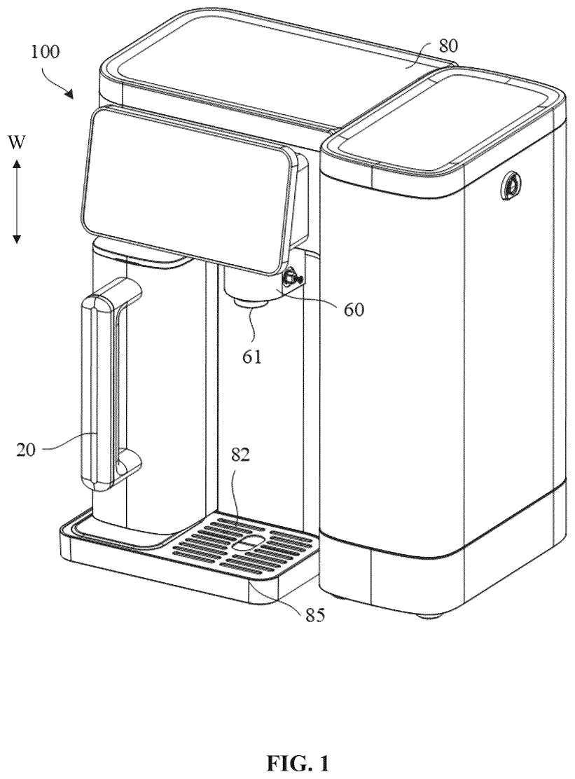

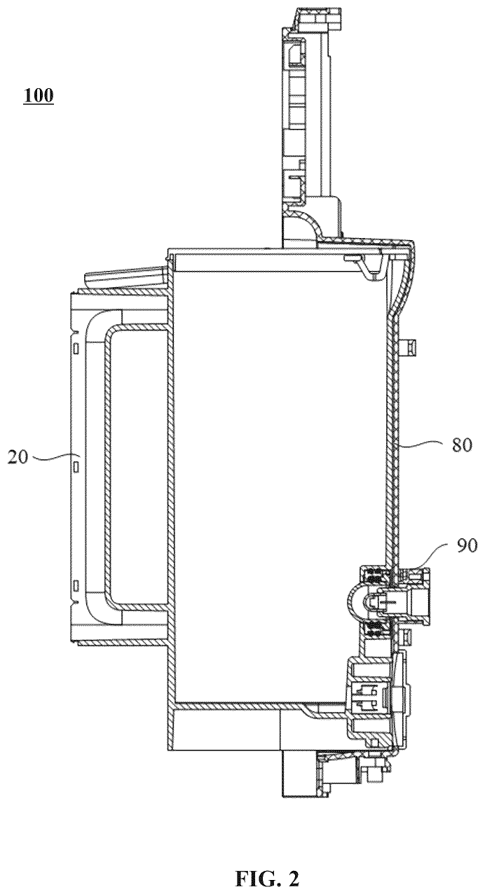

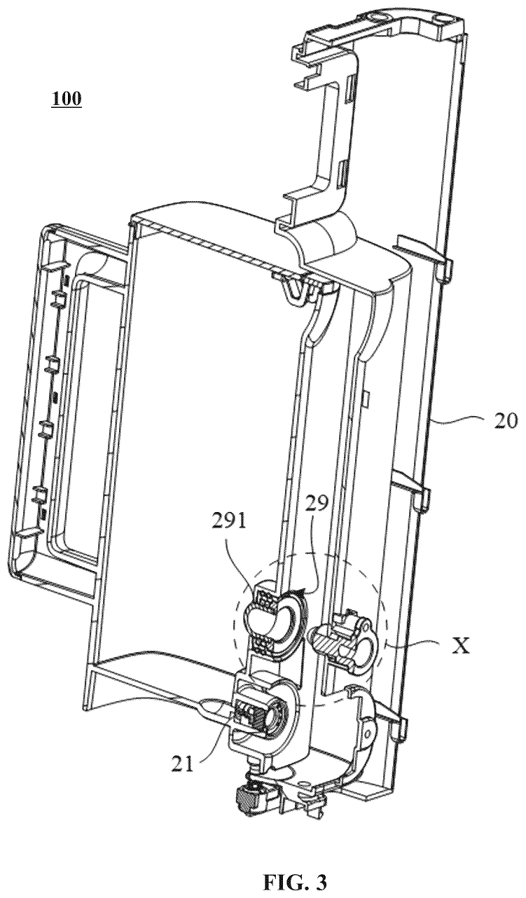

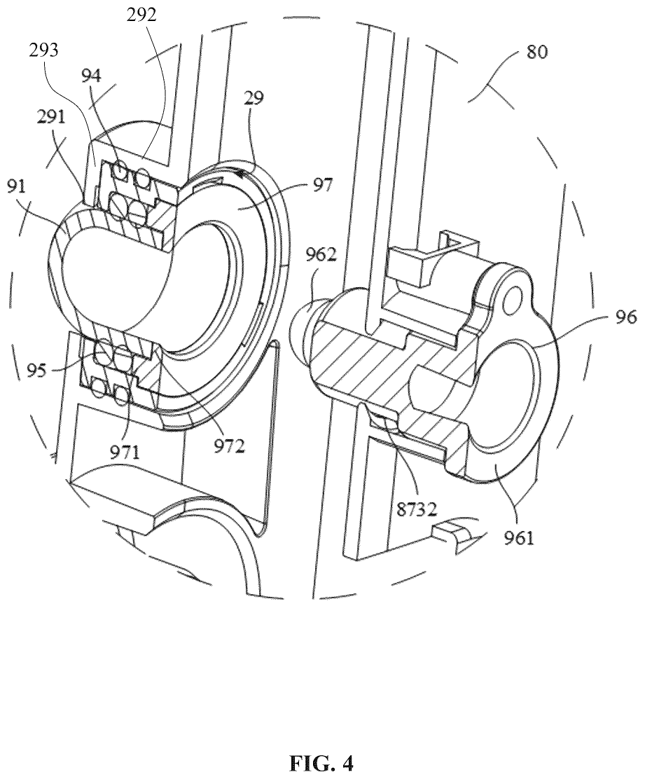

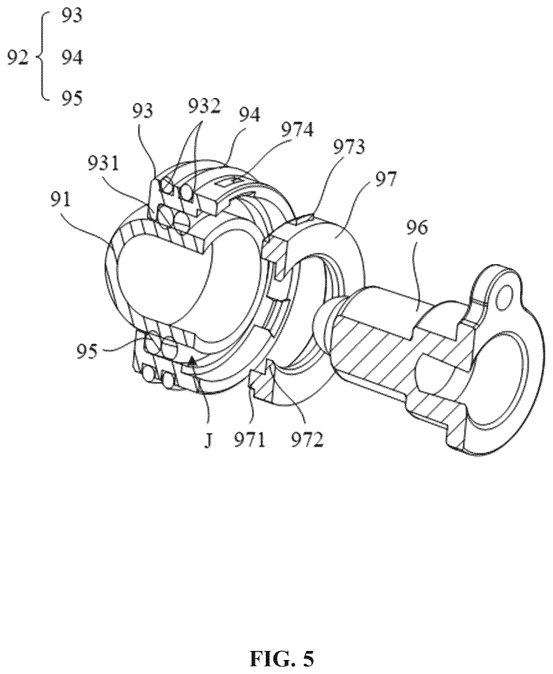

FIG. 1 is a schematic diagram illustrating a structure of a water purifier 100 according to some embodiments of the present disclosure. FIG. 2 is a cross-sectional view of a purified water tank of a water purifier according to some embodiments of the present disclosure. FIG. 3 is a cross-sectional view of a purified water tank of a water purifier from another perspective according to some embodiments of the present disclosure. FIG. 4 is a partial enlarged view of a region X in FIG. 3. FIG. 5 is a schematic diagram illustrating an exploded structure of a sterilization unit of a water purifier according to some embodiments of the present disclosure.

As shown in FIG. 1, FIG. 2, FIG. 3, FIG. 4, and FIG. 5, in some embodiments of the present disclosure, a water purifier 100 is provided and configured to purify water from a water source to be filtered.

In some embodiments, the water purifier 100 includes a housing 80. The water purifier 100 includes a purified water tank 20 detachably disposed on an outer side of the housing 80. The purified water tank 20 is provided with a purified water tank communication port 21 and a first mounting groove 29. The purified water tank communication port 21 is configured to communicate with a purified water supply interface of the water purifier 100. A bottom wall of the first mounting groove 29 is provided with a first mounting port 291. The water purifier 100 includes a sterilization unit 90. The sterilization unit 90 includes a lamp cover 91, a lamp cover locating assembly 92, and a sterilization lamp 96. The lamp cover locating assembly 92 includes a first locating member 93, which is annular in shape, at least one first sealing ring 94, and at least one second sealing ring 95. The lamp cover 91 is located in the first mounting groove 29. A head of the lamp cover 91 is exposed into the purified water tank 20 through the first mounting port 291. The first locating member 93 sleeves an outer peripheral side of the lamp cover 91. The at least one first sealing ring 94 is sealingly disposed between the first locating member 93 and a side groove wall 292 of the first mounting groove 29. The at least one second sealing ring 95 is sealingly disposed between the first locating member 93 and the outer peripheral side of the lamp cover 91. For example, the at least one first sealing ring 94 is sealingly disposed between the first locating member 93 and the side groove wall 292 of the first mounting groove 29 by interference fitting. The at least one second sealing ring 95 is sealingly disposed between the first locating member 93 and the outer peripheral side of the lamp cover 91 by interference fitting. The sterilization lamp 96 is disposed on an outer wall of the housing 80, and when the purified water tank 20 is mounted on the outer side of the housing 80, the sterilization lamp 96 extends into an inner side of the lamp cover 91.

The purified water tank 20 may be used for storing water. For example, the purified water tank 20 may be used for storing purified water filtered by a filter 40 described below.

The water tank communication port 21 refers to a waterway interface provided on the purified water tank 20 to allow water to flow into or out of the purified water tank 20.

The first mounting groove 29 refers to a groove structure disposed on an outer wall of the purified water tank 20. The first mounting groove 29 includes the side groove wall 292 and a bottom wall 293. The bottom wall 293 protrudes toward an inner cavity of the purified water tank 20. The side groove wall 292 is connected the bottom wall 293 and an open end of the first mounting groove 29.

The first mounting port 291 refers to a through hole disposed on the bottom wall 293 of the first mounting groove 29. The first mounting port 291 may serve as a channel for the lamp cover 91 and the sterilization lamp 96 to extend into the inner cavity of the purified water tank 20.

More descriptions regarding the purified water tank 20 may be found in the related descriptions below.

The purified water supply interface refers to a docking interface on the water purifier for delivering purified water to the purified water tank 20.

The housing 80 is configured to accommodate functional components such as the purified water tank 20 and the sterilization unit 90 to provide physical protection for internal components.

In some embodiments, the purified water tank 20 may be detachably disposed on the outer side of the housing 80 in a plurality of ways. For example, the purified water tank 20 may be detachably disposed on the outer side of the housing 80 by means of magnetic attraction connection, snap-fit connection, or the like. As another example, as described below, the outer wall of the housing 80 is provided with a supporting member 81 for placing the purified water tank 20. More descriptions regarding the housing 80 may be found in the related descriptions below.

The sterilization unit 90 is used for sterilizing water stored in the purified water tank 20.

The lamp cover 91 refers to a cover body disposed in the first mounting groove 29 for accommodating and protecting the sterilization lamp 96. For example, the lamp cover 91 may be a tubular structure, one end of the lamp cover 91 is closed (i.e., the head of the lamp cover 91), and another end of the lamp cover 91 has an opening. The lamp cover 91 may be the same as or similar to an outer cover 9-12 described below.

The inner side of the lamp cover 91 refers to an accommodation space enclosed by a housing of the lamp cover 91.

The outer peripheral side of the lamp cover 91 refers to a side of the housing of the lamp cover 91 that is away from the accommodation space.

The lamp cover locating assembly 92 refers to an assembly component for fixing and locating the lamp cover 91 on a wall portion of the purified water tank 20.

The first locating member 93 refers to a rigid component that provides a mounting foundation and support for the at least one first sealing ring 94 and the at least one second sealing ring 95. Merely by way of example, the first locating member 93 may be an annular steel ring.

When the sterilization unit 90 is assembled and the purified water tank 20 is mounted on the outer side of the housing 80, at least a portion of the sterilization lamp 96 is located inside the lamp cover 91. Sterilization light emitted by the sterilization lamp 96 may irradiate through the lamp cover 91 and the first mounting port 291 to sterilize water stored in the purified water tank 20.

In the above solution, the purified water tank 20 is detachably disposed on the outer side of the housing 80. This allows the user to take the purified water tank 20 at any time according to requirements. When the purified water tank 20 is disposed on the outer side of the housing 80, the first locating member 93 sleeves the outer peripheral side of the lamp cover 91. The at least one first sealing ring 94 is sealingly disposed between the first locating member 93 and the side groove wall 292 of the first mounting groove 29. The at least one second sealing ring 95 is sealingly disposed between the first locating member 93 and the outer peripheral side of the lamp cover 91. In this way, sealing can be achieved between the first locating member 93 and the lamp cover 91, and sealing can be achieved between the first locating member 93 and the first mounting groove 29. The head of the lamp cover 91 is exposed into the purified water tank 20 through the first mounting port 291, and the sterilization lamp 96 is configured to be capable of extending into the inner side of the lamp cover 91. Therefore, light emitted by the sterilization lamp 96 may irradiate through the lamp cover 91 into the purified water tank 20 to sterilize water stored in the purified water tank 20.

In addition, the lamp cover locating assembly 92 includes the first locating member 93, and the at least one first sealing ring 94 and the at least one second sealing ring 95 respectively disposed on an outer side and an inner side of the first locating member 93. The first locating member 93 serves as a support skeleton. The at least one first sealing ring 94 and at least one the second sealing ring 95 mainly serve a deformation sealing function. Compared with related technologies that use only a sealing ring with a relatively large radial thickness of the entire sealing ring, radial thicknesses of the at least one first sealing ring 94 and the at least one second sealing ring 95 that undergo deformation are smaller. Aging degrees and aging speeds of the at least one first sealing ring 94 and the at least one second sealing ring 95 are reduced, thereby improving sealing reliability. As the usage time increases, the possibility of water leakage at the joints between the first locating member 93 and the lamp cover 91, and between the first locating member 93 and the first mounting groove 29 becomes smaller.

Merely by way of example, the lamp cover 91 is a light-transmitting structure. For example, the head of the lamp cover 91 may extend into the purified water tank 20 through the first mounting port 291, to allow the sterilization lamp 96 to irradiate a larger range of water as much as possible. For example, the sterilization lamp 96 may be an ultraviolet sterilization lamp.

In some embodiments, a hardness of the first locating member 93 is greater than a hardness of the at least one first sealing ring 94 and a hardness of the at least one second sealing ring 95. This design can further reduce the aging speed of the lamp cover, and improve the overall strength of the lamp cover locating assembly 92. For example, the first locating member 93 may be a metal member, and the at least one first sealing ring 94 and the at least one second sealing ring 95 may be rubber members.

In some embodiments, a count of the at least one first sealing ring 94 is at least two. The at least two first sealing rings 94 are arranged along an axial direction of the first locating member 93. A count of the at least one second sealing ring 95 is at least two. The at least two second sealing rings 95 are arranged along the axial direction of the first locating member 93.

In this way, a plurality of lines of defense are arranged in the axial direction of the first locating member 93, which can minimize the occurrence of leakage.

The axial direction of the first locating member 93 refers to a direction parallel to a central axis of the first locating member 93. In the embodiment, the at least two first sealing rings 94 are distributed at intervals along the axial direction of the first locating member 93, and central axes directions of the at least two first sealing rings 94 are parallel. The at least two second sealing rings 95 are distributed at intervals along the axial direction of the first locating member 93, and central axes directions of the at least two second sealing rings 95 are parallel.

In some embodiments, as shown in FIG. 5, in a case where the count of the at least one first sealing ring 94 is at least two, an outer peripheral surface of the first locating member 93 is provided with at least two second mounting grooves 932, which are annular in shape. Each of the at least two first sealing rings 94 is disposed in the at least two second mounting grooves. In this way, movement of the at least two first sealing rings 94 in the axial direction of the first locating member 93 can be avoided.

An inner peripheral surface of the first locating member 93 is provided with at least one annular stop portion 931. The at least one annular stop portion 931 and an inner peripheral side of the first locating member 93 define a mounting space J, which is annular and semi-open. The at least one second sealing ring 95 is disposed in the mounting space J, which is annular and semi-open.

By providing at least two second mounting grooves 932, at least one first sealing ring 94 can be precisely positioned and limited between the first locating member 93 and the side groove wall 292. By providing the mounting space J, which is annular and semi-open, at least one second sealing ring 95 can be precisely located and limited between the first locating member 93 and the lamp cover 91, thereby ensuring sealing reliability and assembly consistency.

The second mounting groove 932 refers to a groove structure disposed on the outer peripheral surface of the first locating member 93. In some embodiments, the at least two second mounting grooves 932 are arranged at intervals along the axial direction of the first locating member 93.

The inner peripheral surface of the first locating member 93 refers to an inner surface of the first locating member 93 that faces a central hole of the first locating member 93 along a radial direction of the first locating member 93.

The stop portion 931 refers to a limiting structure disposed on the inner peripheral surface of the first locating member 93. The at least one stop portion 931 is configured to restrict the at least one second sealing ring 95 from moving along the axial direction of the first locating member 93. For example, the at least one stop portion 931 is an annular boss disposed on an end of the inner peripheral surface of the at least one first locating member 93 near the first mounting port 291.

The inner peripheral side of the first locating member 93 refers to a side of the first locating member 93 that is close to the central hole of the first locating member 93 along the radial direction of the first locating member 93.

The annular mounting space J refers to an annular groove defined jointly by the at least one stop portion 931, the inner peripheral side of the first locating member 93, and the outer peripheral side of the lamp cover 91. Because an end of the annular mounting space J away from the at least one stop portion 931 has the opening (which may also be referred to as an open end of the annular mounting space J), the annular mounting space J is semi-open.

In some embodiments, as shown in FIG. 4 and FIG. 5, the lamp cover locating assembly 92 further includes a sealing member 97. The sealing member 97 is connected to an end portion of the first locating member 93 facing the purified water tank 20, and abuts against a side of the at least one second sealing ring 95 facing the purified water tank 20. In this way, in combination with the sealing member 97 and the at least one stop portion 931, the axial movement of the at least one second sealing ring 95 along the first locating member 93 can be effectively restricted, thereby preventing the at least one second sealing ring 95 from disengaging from a gap between the first locating member 93 and the lamp cover 91.

The sealing member 97 refers to a structure that closes the open end of the annular mounting space J to axially limit the at least one second sealing ring 95 mounted in the annular mounting space J. For example, the sealing member 97 may be an annular cover plate configured to cover the open end of the annular mounting space J, thereby preventing the at least one second sealing ring 95 from disengaging from the annular mounting space J from the open end of the annular mounting space J.

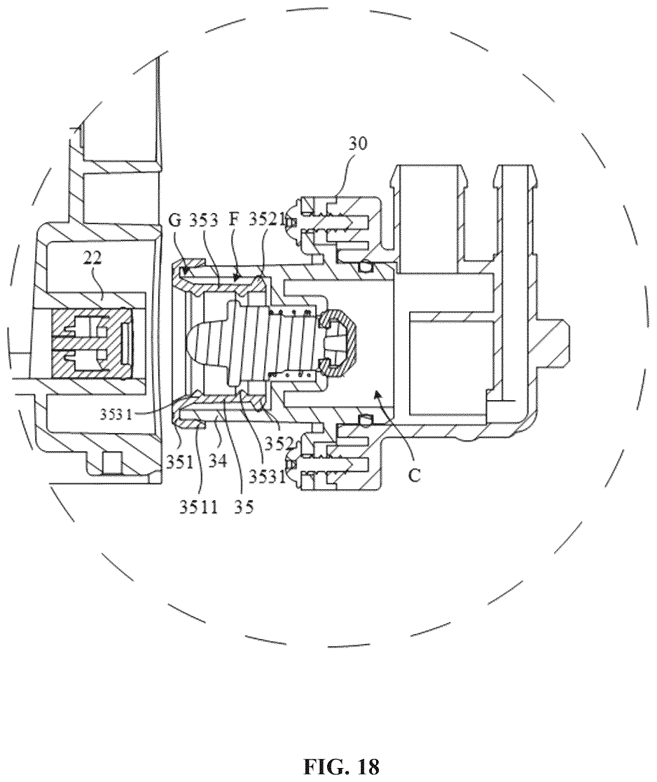

The end portion of the first locating member 93 facing the purified water tank 20 refers to an end of the first locating member 93 close to a side wall of the purified water tank 20. For example, as shown in FIG. 18, the sealing member 97 is connected to an end of the first locating member 93 close to the open end of the first mounting groove 29.

Abutting against refers to the fact that the sealing member 97 is disposed between the at least one second sealing ring 95 and the open end of the annular mounting space J to prevent the at least one second sealing ring 95 from disengaging from the gap between the first locating member 93 and the lamp cover 91.

In some embodiments, the sealing member 97 may be clamp-fit with the first locating member 93. For example, the sealing member 97 is provided with a clamping arm 973, and the first locating member 93 may be provided with a clamping slot 974. The sealing member 97 and the first locating member 93 are connected through a clamping fit between the clamping arm 973 and the clamping slot 974. In this way, the first locating member 93 and the sealing member 97 can be reliably connected as one piece.

The clamping arm 973 refers to an arm structure disposed on an outer peripheral surface of the sealing member 97. For example, the clamping arm 973 may be an arm-shaped protrusion disposed on the outer peripheral surface of the sealing member 97. The clamping arm 973 may be the same as or similar to a clamping block 9-131 described below.

The outer peripheral surface of the sealing member 97 refers to an outer side surface of the sealing member 97 that is away from a central hole of the sealing member 97 along a radial direction of the sealing member 97.

The clamping slot 974 refers to a slot structure formed on the first locating member 93 and configured to engage with the clamping arm 973 in a clamping fit manner. For example, the clamping slot 974 may be a through slot formed on a side surface of the first locating member 93 and penetrating through the first locating member 93. A shape of the clamping arm 973 is adapted to a shape of the clamping slot 974 to facilitate clamping in the clamping slot 974.

When the sealing member 97 is connected to the end portion of the first locating member 93 facing the purified water tank 20, the clamping arm 973 is clamped into the clamping slot 974 from an inner side of the first locating member 93.

In some embodiments, an end portion of the sealing member 97 along the axial direction of the first locating member 93 is provided with a first abutting portion 971 and a second abutting portion 972, which are annular in shape. The first abutting portion 971 is configured to abut against the second sealing ring 95. The second abutting portion 972 is configured to abut against an end portion of the lamp cover 91 facing the purified water tank 20. In this way, movement of the second sealing ring 95 in the axial direction of the first locating member 93 can be prevented, and disengagement of the lamp cover 91 from the first mounting groove 29 can be prevented.

The first abutting portion 971 refers to a portion of the sealing member 97 configured to abut against the at least one second sealing ring 95. For example, the sealing member 97 includes a body and a first annular protrusion (i.e., the first abutting portion 971) disposed on the body and extending toward the first mounting port 291.

When the sealing member 97 is connected to the end portion of the first locating member 93 facing the purified water tank 20, the first abutting portion 971 is located inside the annular mounting space J and is configured to abut against the at least one second sealing ring 95.

The end portion of the lamp cover 91 facing the purified water tank 20 refers to an end of the lamp cover 91 away from the first mounting port 291 of the purified water tank 20. For example, in FIG. 4, the end portion of the lamp cover 91 facing the purified water tank 20 is an open end of the lamp cover 91.

The second abutting portion 972 refers to a portion of the sealing member 97 configured to abut against the end portion of the lamp cover 91 facing the purified water tank 20. For example, the sealing member 97 further includes a second annular protrusion (i.e., the second abutting portion 972) disposed on the body and extending toward a radial inner side of the sealing member 97. When the sealing member 97 is connected to the end portion of the first locating member 93 facing the purified water tank 20, the second abutting portion 972 is located outside the annular mounting space J and abuts against the open end of the lamp cover 91.

In some embodiments, as shown in FIG. 4, the sterilization lamp 96 includes a sterilization lamp mounting bracket 961 and a lamp body 962. The sterilization lamp mounting bracket 961 is disposed at a position of an outer wall of the housing 80 corresponding to the first mounting port 291. The lamp body 962 is disposed at an end portion of the sterilization lamp mounting bracket 961 facing the purified water tank 20. In this way, the sterilization lamp 96 can be mounted at a position corresponding to the lamp cover 91.

The housing 80 is provided with a second mounting port 8732, so that the sterilization lamp mounting bracket 961 can penetrate through the second mounting port 8732 and extend out of the housing 80.

The sterilization lamp mounting bracket 961 refers to a housing or bracket that carries, fixes, and protects the lamp body 962 and other components of the sterilization unit 90. The sterilization lamp mounting bracket 961 may be the same as or similar to a fixing base 9-22 described below.

The lamp body 962 refers to an emission source of sterilization light. The lamp body 962 may be the same as or similar to a UV lamp 9-21 described below.

The second mounting port 8732 refers to a through hole disposed on a side wall of the housing 80. The second mounting port 8732 may serve as a channel for the lamp cover 91 and the sterilization lamp 96 to extend out of the housing 80. In some embodiments, a central axis of the first mounting port 291 coincides with a central axis of the second mounting port 8732.

In some embodiments, as shown in FIG. 3, both the first mounting port 291 and the water tank communication port 21 are located between a top and a bottom of the purified water tank 20, and a setting position of the first mounting port 291 is higher than a setting position of the water tank communication port 21. In this way, sterilization light emitted by the sterilization lamp 96 covers water in the purified water tank 20 as much as possible.

The setting position refers to a position of a component in a height direction of the water purifier 100. For example, the setting position of the first mounting port 291 is a position of a lower edge of the first mounting port 291 in the height direction of the water purifier 100. The setting position of the water tank communication port 21 is a position of a lower edge of the water tank communication port 21 in the height direction of the water purifier 100. The height direction of the water purifier 100 may be represented by an arrow W in FIG. 1 and FIG. 9 to FIG. 11.

In the embodiment, both the first mounting port 291 and the water tank communication port 21 are located on a side wall of the purified water tank 20. The lower edge of the first mounting port 291 is higher than the lower edge of the water tank communication port 21.

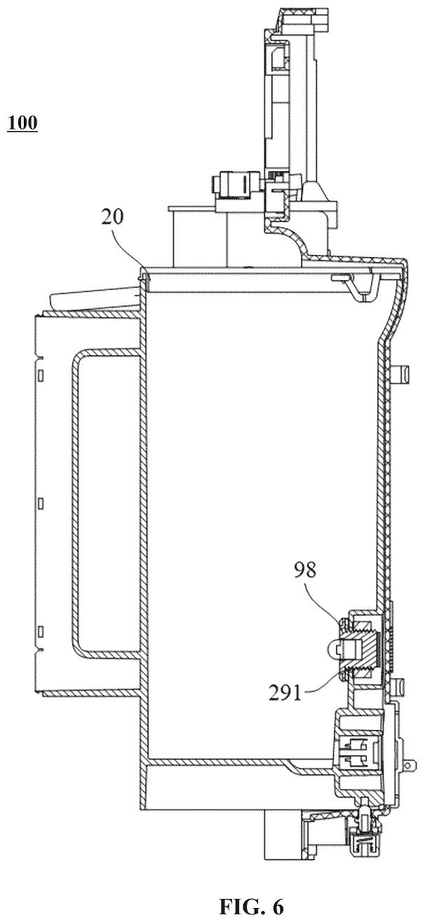

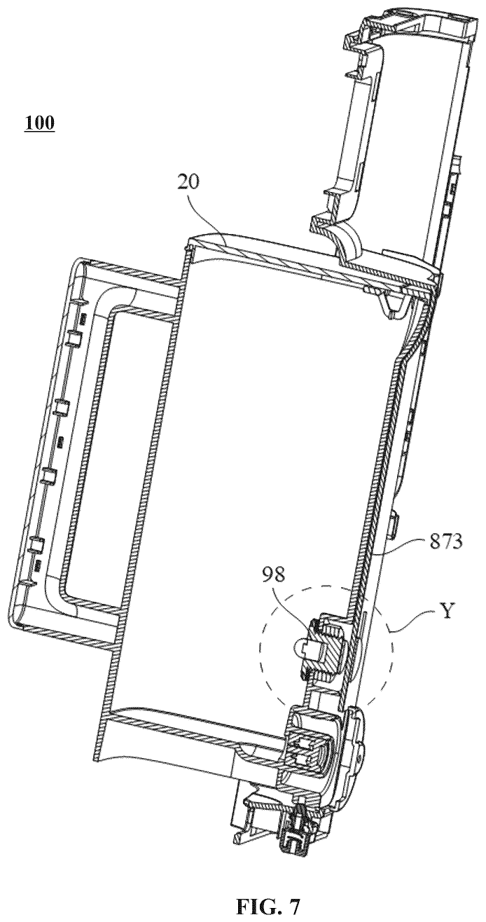

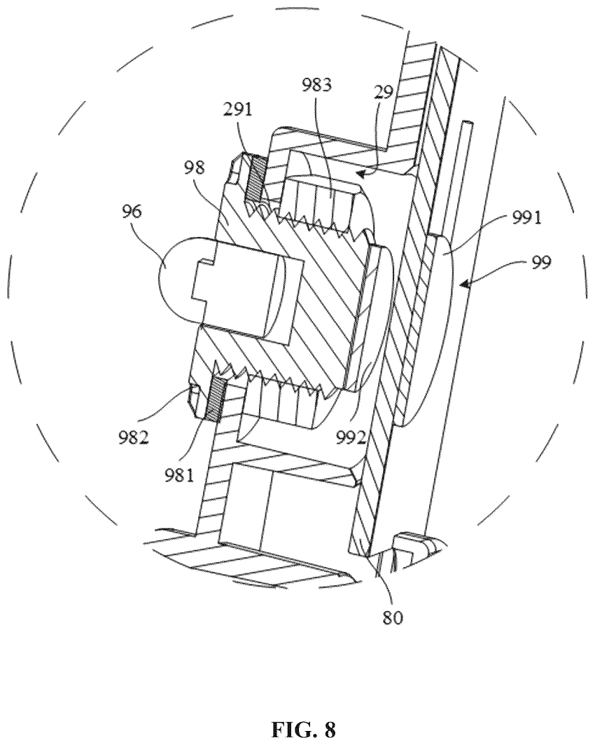

FIG. 6 is a cross-sectional view illustrating another structure of a purified water tank of a water purifier according to some embodiments of the present disclosure. FIG. 7 is a cross-sectional view illustrating another structure of a purified water tank of a water purifier from another perspective according to some embodiments of the present disclosure. FIG. 8 is a partial enlarged view of a region Y in FIG. 7.

As shown in FIG. 6, FIG. 7, and FIG. 8, in the above solution, the housing 80 (e.g., a front panel 873 described below) needs to be provided with an opening used for mounting the sterilization lamp 96, which affects a visual perception of the user. To address the above problems, the sterilization unit 90 may be configured in a wireless mode.

In some embodiments, the sterilization unit 90 may include a lamp bracket 98. The lamp bracket 98 penetrates through the first mounting port 291 and is sealingly connected to the first mounting port 291. For example, a first end of the lamp bracket 98 may be provided with a flange portion 982. The flange portion 982 is lapped on an edge portion of the first mounting port 291, and a third sealing ring 981 is provided between the flange portion 982 and the edge portion of the first mounting port 291. At this time, the sterilization lamp 96 may be disposed at an end portion of the lamp bracket 98 facing an inner side of the purified water tank 20. In this way, the sterilization lamp 96 directly extends into an interior of the purified water tank 20, and an irradiation range within the purified water tank 20 is improved.

In some embodiments, as shown in FIG. 8, the sterilization unit 90 further includes a second mounting member 983 that sleeves the lamp bracket 98. The second mounting member 983 may be located on an outer side of the purified water tank 20. For example, the second mounting member 983 may be located in the first mounting groove 29. The second mounting member 983 is configured to apply a force toward the outer side of the purified water tank 20 to the flange portion 982, so that the flange portion 982 abuts the third sealing ring 981 against an inner wall of the purified water tank 20. In practical application, the second mounting member 983 may abut against the bottom wall 293 of the first mounting groove 29. The second mounting member 983 and the lamp bracket 98 may be in threaded engagement. At this time, the flange portion 982, the at least one first sealing ring 94, and the second mounting member 983 abut against a bottom of the first mounting groove 29 from the inner side and the outer side of the purified water tank 20, respectively.

To locate the sterilization lamp 96, the end portion of the lamp bracket 98 facing the inner side of the purified water tank 20 is provided with a mounting groove. The sterilization lamp 96 is sealingly disposed in the mounting groove.

In some embodiments, the sterilization unit 90 further includes a wireless assembly 99. The wireless assembly 99 includes a wireless transmission unit 991 and a wireless reception unit 992. The wireless transmission unit 991 is disposed on an inner wall of the housing 80 and is electrically connected to a power supply circuit board (not shown in the figure) of the water purifier 100. The wireless reception unit 992 is disposed at an end portion of the lamp bracket 98 facing an outer side of the purified water tank 20. When the purified water tank 20 is assembled to the housing 80 (e.g., when the purified water tank 20 is supported on the supporting member 81), the wireless transmission unit 991 and the wireless reception unit 992 are arranged opposite to each other, to supply power to the sterilization lamp 96 through the wireless reception unit 992.

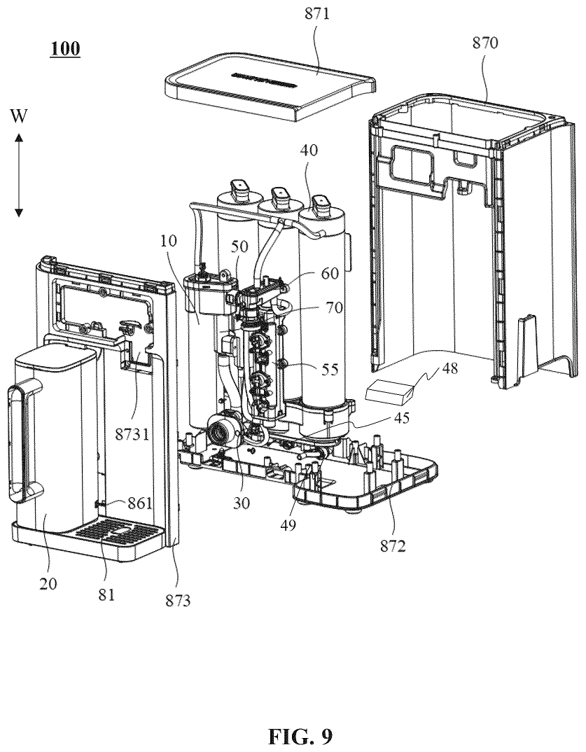

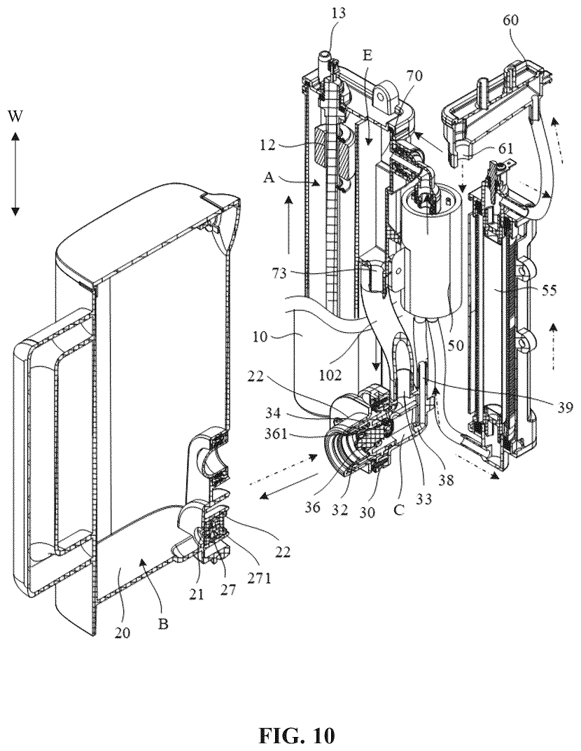

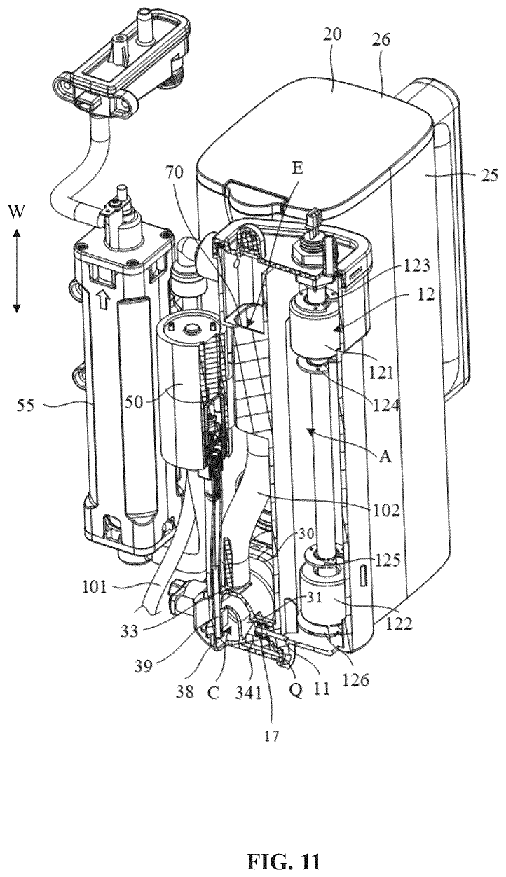

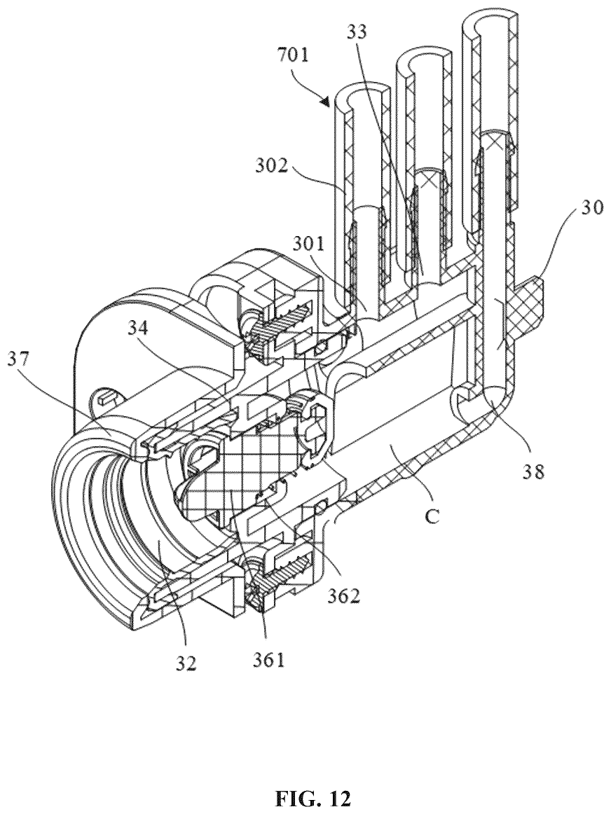

FIG. 9 is a schematic diagram illustrating an exploded structure of a water purifier according to some embodiments of the present disclosure. FIG. 10 is a schematic diagram illustrating an exploded structure of a water purifier from another perspective according to some embodiments of the present disclosure. FIG. 11 is a cross-sectional view of a liquid level box of a water purifier according to some embodiments of the present disclosure. FIG. 12 is a schematic diagram illustrating another structure of a communicating vessel of a water purifier according to some embodiments of the present disclosure.

In some embodiments, as shown in FIG. 1 and FIG. 9 to FIG. 12, the water purifier further includes a liquid level box 10, a communicating vessel 30, the filter 40, and an exhaust member 70. The exhaust member 70 is provided with a first chamber E in communication with atmosphere. The first chamber E communicates with a filter liquid outlet 45 of the filter 40. The purified water tank 20 and the liquid level box 10 communicate with the atmosphere. The liquid level box 10 is internally provided with a water level sensor 12 for detecting a water level. The communicating vessel 30 is provided with a communicating vessel inner cavity C. The communicating vessel inner cavity C communicates with the purified water tank 20, the liquid level box 10, and the first chamber E, respectively. Water filtered by the filter 40 is capable of being input into the exhaust member 70 and the communicating vessel 30 in sequence, and flowing into the liquid level box 10 and the purified water tank 20 through the communicating vessel inner cavity C.

The liquid level box 10 is configured to store purified water filtered by the filter 40. The purified water tank 20 is configured to store filtered purified water. The liquid level box 10 is internally provided with the water level sensor 12. The purified water tank 20 communicates with the liquid level box 10 through the communicating vessel 30. The purified water tank 20 and the liquid level box 10 are in communication with the atmosphere. According to the principle of communicating vessels, a water level inside the liquid level box 10 can reflect a water level inside the purified water tank 20. Therefore, the water level inside the purified water tank 20 is detected by the water level sensor 12 inside the liquid level box 10.

More descriptions regarding the liquid level box 10 and the water level sensor 12 may be found in the related descriptions below.

The atmosphere refers to an environment outside the water purifier 100 with a standard atmospheric pressure.

In some embodiments, the liquid level box 10 is provided with a liquid level box communication port 11 for communicating with the communicating vessel 30. The liquid level box communication port 11 refers to a waterway interface disposed on the liquid level box 10. The liquid level box communication port 11 allows water to flow between a liquid level box inner cavity A of the liquid level box 10 and the communicating vessel inner cavity C of the communicating vessel 30.

The liquid level box inner cavity A refers to a cavity formed by a housing of the liquid level box 10, and is used to store purified water filtered by the filter 40. The purified water filtered by the filter 40 is delivered to the liquid level box inner cavity A through the communicating vessel 30.

The communicating vessel 30 refers to a communication member for communicating the purified water tank inner cavity B with the liquid level box inner cavity A.

As described above, the communicating vessel 30 is provided with the communicating vessel inner cavity C. The communicating vessel inner cavity C communicates with the purified water tank 20, the liquid level box 10, and the first chamber E, respectively. Merely by way of example, water filtered by the filter 40 is capable of being input to the exhaust member 70 and the communicating vessel 30, and flowing into the liquid level box 10 and the purified water tank 20 through the communicating vessel inner cavity C. In addition, the communicating vessel 30 communicates with the filter liquid outlet 45 on a filter body 43 described later and a water taking port of the water purifier 100.

The communicating vessel inner cavity C refers to a cavity formed by a housing of the communicating vessel 30, and is used to temporarily accommodate purified water.

The purified water tank inner cavity B refers to a cavity formed by a housing of the purified water tank 20, and is used to store filtered purified water.

More descriptions regarding the communicating vessel 30 and the communicating vessel inner cavity C may be found in the related descriptions below.

The filter 40 refers to a component configured to remove harmful substances from a water source to be purified and produce clean drinking water. For example, the filter 40 is configured to connect to the water source to be purified to facilitate filtering of the water source to be purified. The purified water after filtering is delivered to the communicating vessel inner cavity C of the communicating vessel 30 and is dispensed to the purified water tank 20 and the liquid level box 10 for storage. More descriptions regarding the filter 40 may be found in the related descriptions below.

As described above, the water purifier 100 further includes the exhaust member 70.

The exhaust member 70 is provided with a first chamber E in communication with the atmosphere. The first chamber E is in communication with a filter liquid outlet 45 of the filter 40 (not shown in the figure).

The exhaust member 70 refers to a component configured to remove air entrained in water. The exhaust member 70 may remove air entrained in water before the purified water enters the purified water tank 20 and the liquid level box 10, thereby solving a series of failures and experience problems caused by air.

The first chamber E is a chamber formed by a housing of the exhaust member 70 for removing air entrained in water.

The filter liquid outlet 45 refers to a water outlet interface on the filter 40. The filter liquid outlet 45 is configured to convey the purified water filtered by the filter 40 to the exhaust member 70. For example, the filter liquid outlet 45 may be a through hole or a pipeline disposed at a bottom of the filter 40 (e.g., a bottom of a filter housing 42 described below).

Air in the filter 40 may be discharged through the exhaust member 70, thereby reducing the amount of air entering the communicating vessel 30 and avoiding water flow obstruction caused by residual air. More descriptions regarding the exhaust member 70 may be found in the related descriptions below.

By providing the exhaust member 70, air in the communicating vessel 30 during initial water production and air entering the filter 40 may be discharged through the exhaust member 70. In other words, the water filtered from the filter 40 is directly exhausted through the exhaust member 70, the amount of air entering the communicating vessel inner cavity C is reduced. This not only solves the problem of vapor sputtering with hot water, but also addresses problems of unstable water form at the water taking port of the water purifier 100 and a relatively slow water output speed, thereby further facilitating smooth water flow.

As shown in FIG. 10, the liquid level box 10 is provided with an air outlet 13 in communication with the atmosphere. The exhaust member 70 is disposed on the liquid level box 10. The first chamber E communicates with the liquid level box inner cavity A of the liquid level box 10, so as to be in communication with the atmosphere through the air outlet 13. Thus, the liquid level box 10 and the exhaust member 70 may be integrally provided, which can reduce the count of components and save mounting steps.

When the user produces water, the filter 40 purifies the water source to be purified. Purified water is pumped to the first chamber E of the exhaust member 70 for air exhausting. After the air exhausting, the purified water is pumped to the communicating vessel inner cavity C.

The communicating vessel inner cavity C communicates with the purified water tank communication port 21 and the liquid level box communication port 11, respectively. The communicating vessel 30 is detachably connected to the purified water tank 20. A portion of the purified water in the communicating vessel inner cavity C enters the purified water tank 20 through the water tank communication port 21. Anther portion of the purified water in the communicating vessel inner cavity C enters the liquid level box 10 through the liquid level box communication port 11.

In some embodiments, the water purifier 100 further includes, a water pump 50, a heater 55, and a water vapor separator 60. The water pump 50 communicates with the communicating vessel inner cavity C of the communicating vessel 30 and the heater 55, respectively. Thus, the water pump 50 may pump water from the liquid level box 10 and the purified water tank 20 to the heater 55 through the communicating vessel 30. The heater 55 communicates with the water vapor separator 60. It should be noted that the communicating vessel 30 is detachably connected to the purified water tank 20.

With such a configuration, when a user takes water, the water pump 50 pumps water from the communicating vessel 30. The water from the liquid level box 10 and the purified water tank 20 simultaneously flows into the water pump 50 through the communicating vessel 30. The water from the water pump 50 flows into the heater 55. After being heated by the heater 55, the water flows into the water vapor separator 60 and flows out from the water vapor separator 60.

The heater 55 is configured to heat the purified water. The water vapor separator 60 is configured to perform water vapor separation on heated purified water. The water vapor separator 60 is provided with a water vapor separator water outlet 61. The water vapor separator water outlet 61 forms a water taking port of the water purifier 100.

As shown in FIG. 9 and FIG. 10, when the user needs to take the purified water, the water pump 50 operates to simultaneously pump water from the purified water tank 20 and the liquid level box 10 to the heater 55 through the communicating vessel 30. After passing through the heater 55, water continues to pass through the water vapor separator 60 and is taken out from the water vapor separator water outlet 61.

When the water level inside the liquid level box 10 is lower than a high liquid level described below, the filter 40 operates to purify the water source to be purified. The purified water enters the liquid level box 10 and the purified water tank 20 through the communicating vessel 30.

Each part of the water purifier 100 is described in detail below with reference to the accompanying drawings.

As shown in FIG. 1 and FIG. 9, the housing 80 is hollow inside. The housing 80 includes a rear panel 870, a top cover 871, a base 872, and a front panel 873. The rear panel 870, the top cover 871, the base 872, and the front panel 873 are collectively enclosed to form an accommodation cavity. The filter 40, the communicating vessel 30, the liquid level box 10, the water pump 50, the heater 55, etc., are disposed in the accommodation cavity. The rear panel 870 and the front panel 873 are disposed around sides of the base 872 to form a main body of the housing 80. The top cover 871 is configured to cover the front panel 873 and the rear panel 870.

In some embodiments, as shown in FIG. 1 and FIG. 9, a portion of the water vapor separator 60 penetrates through the housing 80 and extends to the outer side of the housing 80. The water vapor separator water outlet 61 is located on the portion of the water vapor separator 60 that extends to the outer side of the housing 80. Thus, the user may conveniently take water from the water vapor separator water outlet 61 that is located the outer side of the housing 80. Merely by way of example, an avoidance opening 8731 may be formed in the front panel 873. The water vapor separator water outlet 61 extends to the outer side of the housing 80 through the avoidance opening 8731.

In some embodiments, as shown in FIG. 1, FIG. 9 to FIG. 11, the water purifier 100 further includes a controller 48. The controller 48 is electrically connected to the water level sensor 12 and a booster pump 49. The controller 48 is configured to control the booster pump 49 to stop operating when the liquid level inside the liquid level box 10 is at the high liquid level, thereby stopping water production. The controller 48 is configured to control the booster pump 49 to start operating when the liquid level inside the liquid level box 10 is lower than the high liquid level, to perform the water production. The controller 48 is configured to control the water pump 50 to stop operating when the liquid level inside the liquid level box 10 is at the low liquid level, to stop water output.

In some embodiments, the exhaust member 70 is disposed on an outer side wall of the liquid level box 10. Opposing side walls of the exhaust member 70 and the liquid level box 10 are both provided with communication ports 14 communicating with each other to allow the first chamber E to communicate with the liquid level box inner cavity of the liquid level box 10.

The water level sensor 12 is configured as a float sensor, and the water level sensor 12 includes a first float 121 and a second float 122.

In a height direction of the liquid level box 10 inside the liquid level box 10, a first upper baffle 123, a first lower baffle 124, a second upper baffle 125, and a second lower baffle 126 are provided in sequence. The first float 121 is located between the first upper baffle 123 and the first lower baffle 124, and the second float 122 is located between the second upper baffle 125 and the second lower baffle 126.

The water level sensor 12 is configured to be capable of detecting a liquid level in the liquid level box 10. When the first float 121 abuts against the first upper baffle 123, the liquid level is determined to be at a high liquid level. When the second float 122 abuts against the second lower baffle 126, the liquid level is determined to be at a low liquid level.

The filter 40 includes a filter housing 42 and the filter body 43. The filter housing 42 is provided with a filter inner cavity 44 with an open end, and the filter body 43 is disposed in the filter inner cavity.

The liquid level box 10 communicates with the filter inner cavity 44 of the filter 40 through a third pipeline 103.

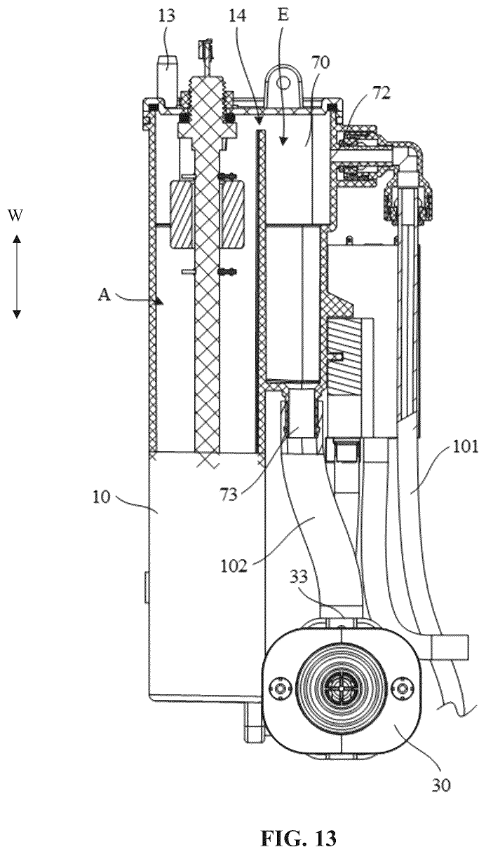

FIG. 13 is a cross-sectional view of a liquid level box of a water purifier from another perspective according to some embodiments of the present disclosure

As described above, as shown in FIG. 13, the exhaust member 70 is disposed on the outer side wall of the liquid level box 10. Each of the opposing side walls of the exhaust member 70 and the liquid level box 10 facing each other is provided with the communication port 14. The two communication ports 14 communicate with each other, so that the first chamber E communicates with the liquid level box inner cavity A. The first chamber E communicates with the liquid level box inner cavity A, and the liquid level box 10 is in communication with the atmosphere, so that the first chamber E of the exhaust member 70 is in communication with the atmosphere through the liquid level box inner cavity A.

Each of the exhaust member 70 and the liquid level box 10 has an independent housing. A portion of the housing of the exhaust member 70 is connected to the outer side wall of the liquid level box 10. Therefore, the portion of the housing of the exhaust member 70 and the outer side wall of the liquid level box 10 face each other. Each of the portion of the housing of the exhaust member 70 and the portion of the housing of the liquid level box 10 is provided with a through hole (i.e., the communication port 14) communicating with each other. The first chamber E communicates with the liquid level box inner cavity A through the communication port 14.

Regarding communication manners between various components, as shown in FIG. 10, FIG. 11, FIG. 12, and FIG. 13, for example, the exhaust member 70 may be provided with an exhaust member liquid inlet 72 and an exhaust member liquid outlet 73. The communicating vessel 30 is provided with a communicating vessel liquid inlet 33 that communicates with the communicating vessel inner cavity C. The exhaust member liquid inlet 72 communicates with the filter liquid outlet 45 through a first pipeline 101. The exhaust member liquid outlet 73 communicates with the communicating vessel liquid inlet 33 of the communicating vessel 30 through a second pipeline 102.

In some embodiments, setting heights of the communication ports 14 on the exhaust member 70 and the liquid level box 10 relative to a bottom wall of the liquid level box 10 are higher than a setting height of the exhaust member liquid inlet 72.

In this way, the water entering the exhaust member 70 from the exhaust member liquid inlet 72 may be prevented from entering the liquid level box 10 through the communication port 14.

The exhaust member liquid inlet 72 refers to a water inlet interface disposed on the exhaust member 70.

The exhaust member liquid outlet 73 refers to a water outlet interface on the exhaust member 70.

The communicating vessel liquid inlet 33 refers to a water inlet interface disposed on the communicating vessel 30.

The first pipeline 101 is a dedicated liquid discharge pipeline connecting the exhaust member liquid inlet 72 and the filter liquid outlet 45. The first pipeline 101 is configured to convey the purified water filtered by the filter 40 to flow into the exhaust member 70. For example, the first pipeline 101 may be a pipeline made of materials such as silicone, rubber, plastic, or the like.

The second pipeline 102 is a dedicated liquid discharge pipeline connecting the exhaust member liquid outlet 73 and the communicating vessel liquid inlet 33. The second pipeline 102 is configured to convey the purified water that has undergone air exhausting in the exhaust member 70 to flow into the communicating vessel 30.

In some embodiments, as shown in FIG. 9 and FIG. 10, further, the communicating vessel liquid inlet 33 communicates with the filter liquid outlet of the filter 40 through the exhaust member 70. A diameter of the communicating vessel liquid inlet 33 is greater than 6 mm, and/or an inner diameter of the second pipeline 102 is greater than 6 mm.

When the diameter of the communicating vessel liquid inlet 33 or the inner diameter of the second pipeline 102 connected to the communicating vessel liquid inlet 33 is less than 6 mm, a process of air in the communicating vessel 30 entering the exhaust member 70 through the second pipeline 102 is obstructed, and a situation of poor exhaust is prone to occur. The water inflow from the exhaust member 70 to the communicating vessel 30 may not be stably and smoothly performed. The water accumulated in the exhaust member 70 may directly enter the liquid level box 10 through the communication port 14. The liquid level inside the liquid level box 10 is high, adversely affecting determination of the liquid level inside the purified water tank 20.

As described above, as shown in FIG. 11, the water level sensor 12 is configured as the float sensor, and the water level sensor 12 includes the first float 121 and the second float 122. In the height direction of the liquid level box 10 inside the liquid level box 10, the first upper baffle 123, the first lower baffle 124, the second upper baffle 125, and the second lower baffle 126 are provided in sequence. The first float 121 is located between the first upper baffle 123 and the first lower baffle 124, and the second float 122 is located between the second upper baffle 125 and the second lower baffle 126.

The water level sensor 12 is configured to be capable of detecting the liquid level inside the liquid level box 10. When the first float 121 abuts against the first upper baffle 123, the liquid level is determined to be at the high liquid level. When the second float 122 abuts against the second lower baffle 126, the liquid level is determined to be at the low liquid level.

The first upper baffle 123, the first lower baffle 124, the second upper baffle 125, and the second lower baffle 126 are mechanical limit structures disposed inside the liquid level box 10. The first upper baffle 123 and the first lower baffle 124 are configured to limit a movement range of the first float 121 in the height direction of the liquid level box 10. The second upper baffle 125 and the second lower baffle 126 are configured to limit a movement range of the second float 122 in the height direction of the liquid level box 10.

The first float 121 and the second float 122 move following the water level inside the liquid level box 10. When the water level inside the liquid level box 10 is higher than or equal to the first upper baffle 123, the first float 121 abuts against the first upper baffle 123. When the water level inside the liquid level box 10 is lower than or equal to the first lower baffle 124, the first float 121 abuts against the first lower baffle 124. When the water level inside the liquid level box 10 is higher than or equal to the second upper baffle 125, the second float 122 abuts against the second upper baffle 125. When the water level inside the liquid level box 10 is lower than or equal to the second lower baffle 126, the second float 122 abuts against the second lower baffle 126.

With such a configuration, whether detecting the high liquid level or the low liquid level, a stroke of the corresponding float is relatively short. Compared to a solution with only one float, this avoids the situation where the float has a long stroke at different liquid levels, is prone to jamming, and consequently causes inaccurate detection results or float failure.

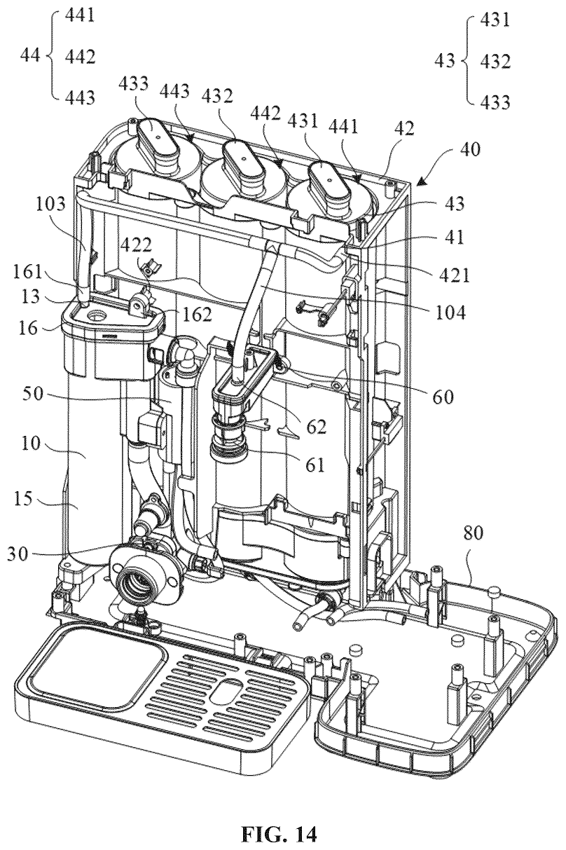

FIG. 14 is a schematic diagram illustrating a structure of a filter of a water purifier according to some embodiments of the present disclosure.

As described above, as shown in FIG. 14, the filter 40 includes a filter housing 42 and the filter body 43. The filter housing 42 is provided with a filter inner cavity 44 with one open end (communicating with the atmosphere). The filter body 43 is disposed in the filter inner cavity 44.

The filter housing 42 is a housing of the filter 40. The filter housing 42 is configured to accommodate other components of the filter 40. For example, the filter housing 42 is a cylindrical structure with one open end. The filter inner cavity 44 is a chamber formed inside the filter housing 42. The filter inner cavity 44 is configured to mount the filter body 43.

The filter body 43 is a component of the filter 40 for filtering impurities. For example, the filter body 43 is a filter element.

The interior of the filter housing 42, i.e., the filter inner cavity 44 is in communication with the atmosphere. The air outlet 13 communicates with the interior of the filter housing 42 of the filter 40, so that the liquid level box 10 is in communication with the atmosphere. In addition, the purified water tank 20 is also in communication with the atmosphere. Therefore, during a process where the water purifier 100 pumps the water to the liquid level box 10 and the purified water tank 20 through the communicating vessel 30, or during a process where the water filtered by the filter 40 enters the liquid level box 10 and the purified water tank 20 through the communicating vessel 30, according to the principle of communicating vessels, the water level inside the liquid level box 10 and the water level inside the purified water tank 20 may be maintained in a substantially equal state. The water level inside the liquid level box 10 can more accurately reflect the water level inside the purified water tank 20.

As described above, the air outlet 13 provided on the liquid level box 10 communicates with an interior of the filter housing 42 of the filter 40. For example, the liquid level box 10 (the air outlet 13) communicates with the interior of the filter 40 (i.e., the filter inner cavity 44 inside the filter housing 42) through a third pipeline 103.

The third pipeline 103 is a dedicated exhaust pipeline connecting the interior of the filter 40 and the interior of the liquid level box 10. A material of the third pipeline 103 may be the same as or similar to the material of the first pipeline 101. The third pipeline 103 may establish an indirect channel for the liquid level box 10 to be in communication with the atmosphere, so that the interior of the liquid level box 10 is in communication with the atmosphere.

In some embodiments, the liquid level box 10 includes a box body 15 and a box cover 16 sealingly disposed on the box body 15. The air outlet 13 is disposed on the box cover 16.

Merely by way of example, as described above, the filter housing 42 is provided with a filter housing air inlet 41 communicating with the filter inner cavity 44. Two ends of the third pipeline 103 are respectively connected to the air outlet 13 and the filter housing air inlet 41, so that the liquid level box 10 is in communication with the atmosphere.

It should be understood that the filter inner cavity necessarily has an opening for accessing the filter body 43, and the filter inner cavity 44 is in communication with the atmosphere. The air outlet 13 of the liquid level box 10 communicates with the filter inner cavity 44 of the filter 40 through the third pipeline 103. The water purifier 100 has a more aesthetically pleasing overall appearance without providing a new opening on the housing 80 of the water purifier 100.

Merely by way of example, the filter housing 42 is provided with a filter extension tube 421 communicating with the interior of the filter housing 42 through the filter housing air inlet 41. A position of the box cover 16 corresponding to the air outlet 13 is provided with a liquid level box extension tube 161. The two ends of the third pipeline 103 are connected to the filter extension tube 421 and the liquid level box extension tube 161, respectively. With such a configuration, connection of the two ends of the third pipeline 103 to the filter housing 42 and the liquid level box 10 is facilitated.

In some embodiments, the box body 15 is provided with a first mounting portion 162. The filter housing 42 is provided with a second mounting portion 422. The first mounting portion 162 is connected to the second mounting portion 422 to connect the liquid level box 10 to the filter 40. It should be understood that a count of the first mounting portion 162 and a count of the second mounting portion 422 may be at least two. For example, a portion of the at least two first mounting portions 162 may be disposed on the box body 15. A portion of the at least two second mounting portions 422 corresponding to the portion of the at least two first mounting portions 162 is disposed at a position of the filter housing corresponding to the portion of the at least two first mounting portions 162.

As described above, the water pump 50 communicates with the communicating vessel 30 and the heater 55, respectively. The water pump 50 is configured to pump water from the liquid level box 10 and the purified water tank 20 to the heater 55 through the communicating vessel 30.

In some embodiments, the water vapor separator 60 includes a water vapor separator air outlet 62 and the water vapor separator water outlet 61. The water vapor separator air outlet 62 communicates with the interior of the filter housing 42. In this way, steam discharged from the water vapor separator air outlet 62 may be discharged to the atmosphere through the filter housing 42.

The water vapor separator air outlet 62 refers to an exhaust interface of the water vapor separator 60. The water vapor separator air outlet 62 is configured to separate water vapor generated by heating of the heater 55 from liquid water and safely discharge the water vapor from the water vapor separator 60.

The water vapor separator water outlet 61 refers to a water outlet interface of the water vapor separator 60. The water vapor separator water outlet 61 is a water taking port of the water purifier 100 for the user.

In some embodiments, the filter 40 includes three-stage filtration, so that the filtration effect is better.

For example, the filter body 43 includes a first-stage filter 431, a second-stage filter 432, and a third-stage filter 433 connected in sequence. The filter inner cavity 44 includes a first-stage filter inner cavity 441, a second-stage filter inner cavity 442, and a third-stage filter inner cavity 443 that are in fluid communication in sequence. The first-stage filter 431 is accommodated in the first-stage filter inner cavity 441. The second-stage filter 432 is accommodated in the second-stage filter inner cavity 442. The third-stage filter 433 is accommodated in the third-stage filter inner cavity 443. The air outlet 13 communicates with the first-stage filter inner cavity 441.

The filter body 43 is configured as the first-stage filter 431, the second-stage filter 432, and the third-stage filter 433 connected in sequence, so that the filtration effect is better.

Further, the water purifier 100 further includes a booster pump. The booster pump is configured to pump the water to be purified into the filter body 43. The water source is purified in the filter body 43. The booster pump is provided as a power source for water production of the purifier. In addition to water sources with a certain water pressure such as tap water pipes, the water purifier 100 can be applied to different types of water sources, such as water sources in water storage tanks in daily life.

In some embodiments of the present disclosure, as shown in FIG. 10 and FIG. 11 described above, the water pump 50 communicates with the communicating vessel 30 and the heater 55, respectively. The water pump 50 is used for pumping water from the liquid level box 10 and the purified water tank 20 to the heater 55 through the communicating vessel 30. The water vapor separator 60 communicates with the heater 55. The water vapor separator 60 is used for performing water vapor separation on the water heated by the heater 55.

With such a configuration, when the user takes water, the water pump 50 pumps water from the communicating vessel 30. Water in the liquid level box 10 and the purified water tank 20 flows into the water pump 50 simultaneously. Water from the water pump 50 flows into the heater 55, and after penetrating through the heater 55, water flows into the water vapor separator 60 and flows out from the water vapor separator 60.

In some embodiments, as shown in FIG. 14, the water vapor separator air outlet 62 communicates with the third pipeline 103 through a fourth pipeline 104.

The fourth pipeline 104 refers to a dedicated pipeline for guiding and discharging high-temperature steam. The steam enters the filter housing 42 through the fourth pipeline 104 and the third pipeline 103, and is finally discharged into the atmosphere through an open end of the filter housing 42.

In this way, steam separated from the water vapor separator air outlet 62 may be discharged to the atmosphere through the filter housing 42. A count of pipelines can be reduced, so that the structure is more compact.

Regarding communication between the purified water tank 20 and the atmosphere, for example, as shown in FIG. 11, the purified water tank 20 includes a purified water tank body 25 and a water tank cover 26 openably and closably covering the purified water tank body 25. A gap is provided between the purified water tank body 25 and the water tank cover 26, so that the purified water tank 20 communicates with the atmosphere. In this way, when the user needs a large amount of water, the user may open the water tank cover 26 and pour water out to take the water.

In some embodiments, the water vapor separator air outlet 62 is disposed at a top end portion of the water vapor separator 60. The third pipeline 103 and the fourth pipeline 104 are located on a top side of the liquid level box 10 and the water vapor separator 60.

In this way, lengths of the third pipeline 103 and the fourth pipeline 104 may be set to be relatively short. Combined with the characteristic of water vapor rising upward, water vapor is discharged more smoothly.

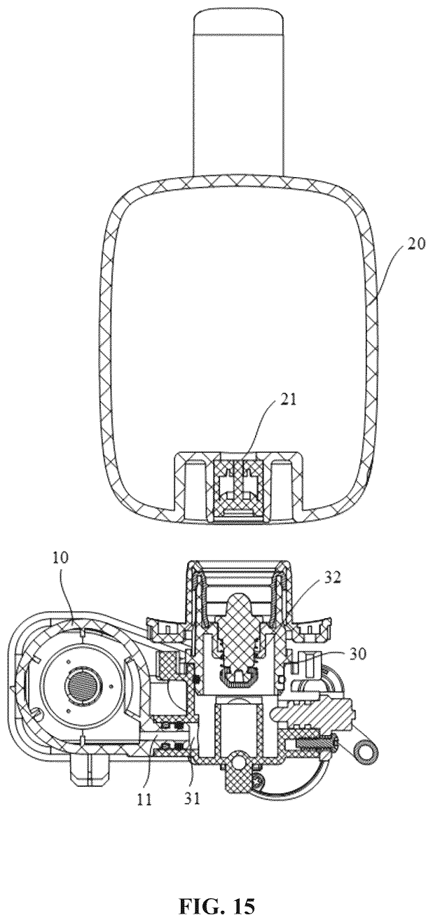

FIG. 15 is a schematic cross-sectional view of the water purifier 100 according to some embodiments of the present disclosure.

In some embodiments of the present disclosure, as described above, the communicating vessel 30 communicates with the liquid level box 10 and the purified water tank 20, respectively. Merely by way of example, as shown in FIG. 10 and FIG. 15, the liquid level box 10 is provided with a liquid level box communication port 11. The purified water tank 20 is provided with a water tank communication port 21. The communicating vessel 30 is further provided with a second communication port 31 and a first communication port 32. The second communication port 31 is connected to the liquid level box communication port 11. The first communication port 32 is connected to the purified water tank communication port 21. In this way, the communicating vessel 30 communicates with the liquid level box 10 and the purified water tank 20, respectively.

In some embodiments, as shown in FIG. 10 and FIG. 11, the communicating vessel 30 is further provided with a communicating vessel liquid outlet 38. The communicating vessel liquid outlet 38 communicates with the water taking port of the water purifier 100. A setting height of the liquid level box communication port 11 relative to a bottom of the water purifier 100 is higher than a setting height of the communicating vessel liquid outlet 38.

With such a configuration, liquid in the liquid level box 10 can flow out of the communicating vessel 30 through the communicating vessel liquid outlet 38 relatively smoothly. This prevents the situation where the liquid level box 10 fails to drain properly, resulting in water accumulation within the liquid level box 10, and the purified water provided to the water taking port is mixed with the accumulated water.

Merely by way of example, the communicating vessel 30 is provided with an extension tube 39. The extension tube 39 penetrates through a wall portion of the communicating vessel 30 from an outer side (e.g., a top side) of the communicating vessel 30 and extends to a bottom position of the communicating vessel inner cavity C. An end portion of the extension tube 39 located inside the communicating vessel inner cavity C forms the communicating vessel liquid outlet 38.

Communication between the water pump 50 and the communicating vessel 30 is implemented by connecting the communicating vessel liquid outlet 38 to an inlet of the water pump 50 through a pipeline. An outlet of the water pump 50 is also connected to the heater 55 through another pipeline to deliver the purified water in the communicating vessel 30 to the heater 55. The water pump 50 may be connected to an outer wall of the exhaust member 70 by fasteners such as screws.

In some embodiments, a setting height of the communicating vessel liquid inlet 33 relative to the bottom of the water purifier 100 is higher than setting heights of the liquid level box communication port 11, the purified water tank communication port 21, and the communicating vessel liquid outlet 38. The communicating vessel liquid inlet 33 may be disposed at a topmost portion of the communicating vessel 30. Therefore, the purified water entering the communicating vessel 30 from the communicating vessel liquid inlet 33 can smoothly enter the liquid level box 10 and the purified water tank 20.

As shown in FIG. 1, and FIG. 9 to FIG. 15, both water production and water pumping of the water purifier 100 need to pass through the communicating vessel 30. During a process of water production, if a volume of the communicating vessel 30 is small, air cannot be discharged smoothly. The communicating vessel inner cavity C may be considered to communicate with the filter liquid outlet of the filter 40. For example, the filter liquid outlet of the filter 40 may communicate with the communicating vessel liquid inlet 33 through a pipeline (not shown in the figure). In this case, the communicating vessel liquid inlet 33 may simultaneously communicate with the filter liquid outlet 45 and the exhaust member 70, or may only communicate with the filter liquid outlet and not communicate with the exhaust member 70.

In some embodiments, an exhaust portion 701 communicating with the atmosphere is provided on the communicating vessel 30. The exhaust portion 701 communicates with the communicating vessel inner cavity C, thereby facilitating the smooth discharge of air from the communicating vessel 30 during the process of water production and the process of water pumping of the water purifier 100. This ensures unimpeded water flow and allows real-time balance between the water levels inside the purified water tank 20 and the float box. When the communicating vessel liquid inlet 33 only communicates with the filter liquid outlet and does not communicate with the exhaust member 70, water filtered by the filter 40 does not pass through the exhaust member 70. The water directly enters the communicating vessel inner cavity C from the communicating vessel liquid inlet 33. The exhaust portion 701 is used for air exhausting.

Merely by way of example, a top of the communicating vessel 30 is provided with an exhaust port 301 that communicates with the communicating vessel inner cavity C. The exhaust port 301 forms the exhaust portion 701. To facilitate smooth discharge of air from the communicating vessel 30, an exhaust tube 302 is provided at the exhaust port 301. The exhaust tube 302 extends along the height direction of the water purifier 100.

It should be noted that, in another possible implementation, the communicating vessel liquid inlet 33 may be simultaneously in communication with the exhaust member 70 and the filter liquid outlet 45. A portion of the water from the filter 40 may enter the communicating vessel 30 through the exhaust member 70, and another portion of the water from the filter 40 may enter the communicating vessel 30 directly through the pipeline communicating with the communicating vessel liquid inlet 33. In this case, air exhausting may be performed simultaneously through the exhaust member 70 and the exhaust portion 701.

As shown in FIG. 10 and FIG. 15, the operation process of the water purifier 100 according to the embodiments of the present disclosure is described below.

When the user needs to take the purified water, as shown by the dashed arrows in FIG. 10, the water pump 50 operates. The purified water in the purified water tank 20 enters the communicating vessel inner cavity C through the purified water tank communication port 21 and the first communication port 32. The purified water in the liquid level box 10 enters the communicating vessel inner cavity C through the liquid level box communication port 11 and the second communication port 31. Driven by the water pump 50, the purified water in the communicating vessel inner cavity C enters the water pump 50 through the communicating vessel liquid outlet 38, and enters the heater 55 communicating with the water pump 50. When the purified water enters the heater 55, the heater 55 may operate to heat the purified water. When the heater 55 does not operate, the purified water is not heated. Water entering the heater 55 finally enters the water vapor separator 60. Heated purified water undergoes water-vapor separation through the water vapor separator 60, and then the purified water flows out from the water vapor separator water outlet 61. If the purified water is not heated in the heater 55, the purified water directly flows out through the water vapor separator water outlet 61. In this process, the water pump 50 serves as a driving source for the entire circulation.

During the process of water production, as shown in FIG. 9, FIG. 10 and FIG. 11 and as shown by the solid arrows, a booster pump 49 operates. The filter 40 purifies the water source to be purified, and delivers the purified water to the first chamber E of the exhaust member 70 through the first pipeline 101. The purified water enters the communicating vessel inner cavity C through the exhaust member liquid outlet 73, the second pipeline 102, and the communicating vessel liquid inlet 33. A portion of the purified water entering the communicating vessel inner cavity C enters the purified water tank 20 through the first communication port 32 and the purified water tank communication port 21. Another portion of the purified water enters the liquid level box 10 through the second communication port 31 and the liquid level box communication port 11. Specifically, during the process of water production, when the water level inside the liquid level box 10 is lower than the high liquid level, the filter 40 operates to purify the water source to be purified. The purified water enters the liquid level box 10 and the purified water tank 20 respectively through the above process. In this process, the booster pump serves as a driving source for the entire circulation.

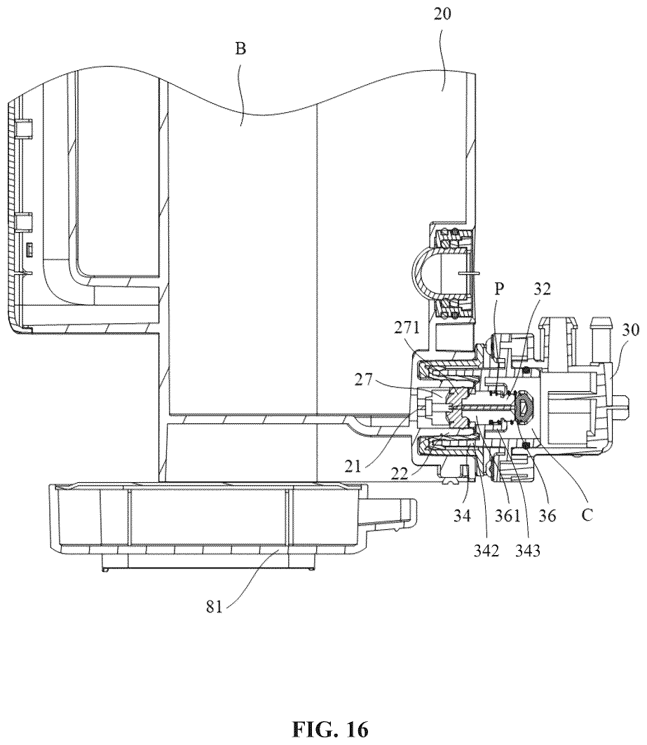

FIG. 16 is a schematic diagram illustrating a structure of a first communication port being mated with a water tank communication port of a water purifier according to some embodiments of the present disclosure.

In the embodiments of the present disclosure, as shown in FIG. 10 to FIG. 11, and FIG. 15 to FIG. 16, the liquid level box 10 is provided with the liquid level box communication port 11, and a volume of the purified water tank inner cavity B of the purified water tank 20 is greater than a volume of the liquid level box inner cavity A of the liquid level box 10. As described above, the water filtered by the filter 40 may flow into the liquid level box 10 and the purified water tank 20 through the communicating vessel inner cavity C.

A minimum cross-sectional area of a first communication channel P for communicating the purified water tank communication port 21 with the communicating vessel inner cavity C is greater than a minimum cross-sectional area of a second communication channel Q for communicating the liquid level box communication port 11 with the communicating vessel inner cavity C.

The first communication channel P refers to a water channel formed when the water tank communication port 21 communicates with the communicating vessel inner cavity C. The first communication channel P is configured for water to flow between the purified water tank 20 and the communicating vessel 30.

The minimum cross-sectional area of the first communication channel P refers to a minimum value among cross-sectional areas of a plurality of cross-sections perpendicular to a central axis direction of the first communication channel P.

More descriptions regarding the first communication channel P and the minimum cross-sectional area thereof may be found in the related descriptions below.

The second communication channel Q refers to a water channel formed when the liquid level box communication port 11 communicates with the communicating vessel inner cavity C. The second communication channel Q is configured for water to flow between the liquid level box 10 and the communicating vessel 30.

The minimum cross-sectional area of the second communication channel Q refers to a minimum value among cross-sectional areas of a plurality of cross-sections perpendicular to a central axis direction of the second communication channel Q.

More descriptions regarding the second communication channel Q and the minimum cross-sectional area thereof may be found in the related descriptions below.

More descriptions regarding the liquid level box communication port 11, the liquid level box inner cavity A, the purified water tank inner cavity B, and the communicating vessel inner cavity C may be found in the related descriptions below.

The volume of the purified water tank inner cavity B of the purified water tank 20 is greater than the volume of the liquid level box inner cavity A of the liquid level box 10. If a water inflow/outflow speed of the purified water tank 20 is the same as a water inflow/outflow speed of the liquid level box 10, a situation may easily occur where, during use of the water purifier 100, the liquid level inside the purified water tank 20 is temporarily higher than the liquid level inside the liquid level box 10. In the present disclosure, by making the minimum cross-sectional area of the first communication channel P greater than the minimum cross-sectional area of the second communication channel Q, a water inflow/outflow volume per unit time of the purified water tank 20 becomes greater than a water inflow/outflow volume per unit time of the liquid level box 10. That is, the water outflow speed of the purified water tank 20 with a larger volume is made greater than the water outflow speed of the liquid level box 10 with a smaller volume. This design can compensate for a temporary liquid level height difference caused by a volume difference between the purified water tank 20 and the liquid level box 10. Therefore, during use of the water purifier 100, the liquid level inside the purified water tank 20 and the liquid level inside the liquid level box 10 remain consistent in real time. The water level detected by a water level sensor 12 inside the liquid level box 10 can always truly reflect the water level inside the purified water tank 20, thereby avoiding repeated water production.

In some embodiments, a cross-sectional area S1 of the purified water tank inner cavity B along the height direction of the water purifier 100 and a cross-sectional area S3 of the liquid level box inner cavity A along the height direction of the water purifier 100 satisfy: S1>S3.

A bottom wall of the purified water tank inner cavity B is configured to be flush with a bottom wall of the liquid level box inner cavity A.

The communicating vessel 30 is disposed in the housing 80 and provided with the communicating vessel inner cavity C that communicates with the purified water supply interface in the water purifier 100. The communicating vessel 30 is provided with a communicating vessel connection tube 34 that communicates with the communicating vessel inner cavity C. An inner wall of the communicating vessel connection tube 34 is provided with a sealing ring 35. Two axial ends of the sealing ring 35 abut against the inner wall of the communicating vessel connection tube 34.

The purified water tank 20 is provided with a purified water tank connection tube 22. The purified water tank connection tube 22 communicates with the purified water tank inner cavity B of the purified water tank 20 and is disposed at a position corresponding to the water tank communication port 21. The purified water tank connection tube 22 is configured to be capable of being inserted into the communicating vessel connection tube 34 to enable communication between the communicating vessel inner cavity C and the purified water tank inner cavity B.

An inner peripheral surface of the first sealing section 353 between the two axial ends of the sealing ring 35 is convexly provided with at least two annular interference fit portions 3531. The at least two interference fit portions 3531 are arranged at intervals along an axial direction of the sealing ring 35. The at least two interference fit portions 3531 are configured to be in interference fit with the purified water tank connection tube 22.

A count of the at least two interference fit portions 3531 is two, and a support protrusion 354 is provided between regions on an outer peripheral surface of the sealing ring 35 corresponding to the two interference fit portions 3531.

An outer wall of the housing 80 is provided with the supporting member 81. The purified water tank 20 is detachably disposed on the supporting member 81, such that the purified water tank 20 is mounted on the outer side of the housing 80.

As described above, the communicating vessel 30 is disposed in the housing 80 and provided with the communicating vessel inner cavity C that communicates with the purified water supply interface in the water purifier 100. The communicating vessel 30 is provided with a communicating vessel connection tube 34 that communicates with the communicating vessel inner cavity C. In some embodiments, the communicating vessel connection tube 34 corresponds to a setting position of the first communication port 32.

The communicating vessel connecting tube 34 refers to a tubular structure connected to the communicating vessel inner cavity C and configured to be connected to the purified water tank connection tube 22.

As described above, the purified water tank 20 is provided with a purified water tank connection tube 22. The purified water tank connection tube 22 corresponds to the setting position of the purified water tank communication port 21. The purified water tank connection tube 22 communicates with the purified water tank inner cavity B of the purified water tank 20, and is disposed at the position corresponding to the water tank communication port 21. The purified water tank connection tube 22 is configured to be inserted into the communicating vessel connection tube 34 to enable communication between the communicating vessel inner cavity C with the purified water tank inner cavity B.

A partial tube section of the communicating vessel connection tube 34 not inserted by the purified water tank connection tube 22 and the purified water tank connection tube 22 together define the first communication channel P. A position with the minimum cross-sectional area of the first communication channel P is located on the partial tube section of the communicating vessel connection tube 34 not inserted by the purified water tank connection tube 22.

The purified water tank connection tube 22 refers to a tubular structure of the purified water tank 20 connected to the purified water tank inner cavity B.

The purified water tank connection tube 22 being disposed at a position corresponding to the water tank communication port 21 refers to the fact that the setting position of the communicating vessel connecting tube 34 and the setting position of the water tank communication port 21 spatially match each other. This arrangement facilitates insertion and removal of the communicating vessel connecting tube 34.

The communicating vessel connecting tube 34 and the purified water tank connection tube 22 are in plug-in connection, thereby jointly defining the first communication channel P to achieve detachable connection between the communicating vessel 30 and the purified water tank 20.

Merely by way of example, as shown in FIG. 16, along a central axis direction of the communicating vessel connecting tube 34, the communicating vessel connecting tube 34 may be divided into a first tube section 342 and a second tube section 343. The second tube section 343 is connected to an end of the first tube section 342 close to the communicating vessel inner cavity C. An inner diameter of the second tube section 343 is less than an inner diameter of the first tube section 342 and an outer diameter of the purified water tank connection tube 22.

When the purified water tank connection tube 22 is inserted into the communicating vessel connecting tube 34, a projection of the first tube section 342 coincides with a projection of the purified water tank connection tube 22 in a direction perpendicular to the central axis of the communicating device connecting pipe 34. That is, the first tube section 342 is a portion of the communicating vessel connecting tube 34 into which the purified water tank connection tube 22 is inserted. The purified water tank connection tube 22 is not inserted into the second tube section 343. The second tube section 343 is a portion of the communicating vessel connecting tube 34 into which the purified water tank connection tube 22 is not inserted. At this time, an inner wall of the second tube section 343 and an inner wall of the purified water tank connection tube 22 jointly form a liquid channel, i.e., the first communication channel P.

Because the inner diameter of the second tube section 343 is less than the outer diameter of the purified water tank connection tube 22, a cross-sectional area of a portion of the first communication channel P corresponding to the second tube section 343 is the smallest. In some embodiments, the minimum cross-sectional area of the first communication channel P may be equal to the inner diameter of the second tube section 343

In some embodiments, the communicating vessel 30 is provided with a communicating vessel insertion tube 341 that communicates with the communicating vessel inner cavity C. The communicating vessel insertion tube 341 corresponds to a setting position of the second communication port 31.

The liquid level box 10 is provided with a liquid level box insertion tube 17. The liquid level box insertion tube 17 communicates with the liquid level box inner cavity A. The liquid level box insertion tube 17 is inserted into the communicating vessel insertion tube 341.

A partial tube section of the communicating vessel insertion tube 341 not inserted by the liquid level box insertion tube 17 and the liquid level box insertion tube 17 together define the second communication channel Q. A position with the minimum cross-sectional area of the second communication channel Q is located inside the liquid level box insertion tube 17.

The communicating vessel insertion tube 341 refers to a tubular structure connected to the communicating vessel inner cavity C and configured to be connected to the liquid level box insertion tube 17.

The liquid level box insertion tube 17 refers to a tubular structure connected to the liquid level box inner cavity A and configured to be connected to the communicating vessel insertion tube 341.

The liquid level box insertion tube 17 and the communicating vessel insertion tube 341 are in plug-in connection, thereby jointly defining the second communication channel Q to achieve detachable connection between the communicating vessel 30 and the liquid level box 10.

A formation manner of the second communication channel Q may be the same as or similar to a formation manner of the first communication channel P. More descriptions regarding formation of the second communication channel Q may be found in the related descriptions of the first communication channel P. In some embodiments, the minimum cross-sectional area of the second communication channel Q may be equal to an inner diameter of the liquid level box insertion tube 17.

In some embodiments, a cross-sectional area S1 of the purified water tank inner cavity B along the height direction of the water purifier 100, a minimum cross-sectional area S2 of the first communication channel P, the cross-sectional area S3 of the liquid level box inner cavity A along the height direction of the water purifier 100, and a minimum cross-sectional area S4 of the second communication channel Q satisfy:

S3/S4=K*S1/S2

where K denotes a drag coefficient of fluid in the liquid level box communication port 11, and a cross-section of the purified water tank inner cavity B and a cross-section of the liquid level box inner cavity A remain unchanged along the height direction of the water purifier 100.

In addition, a value of the drag coefficient of fluid K changes with a hole depth or shape at the liquid level box communication port 11.

The cross-sectional area S1 refers to an area of a cross-section of the purified water tank inner cavity B perpendicular to the height direction of the water purifier 100.

The minimum cross-sectional area S2 refers to a cross-sectional area of a portion of the first communication channel P corresponding to the second tube section 343. For example, the minimum cross-sectional area S2 may be a cross-sectional area of the second tube section 343.

The cross-sectional area S3 refers to an area of a cross-section of the liquid level box inner cavity A perpendicular to the height direction of the water purifier 100.

The minimum cross-sectional area S4 refers to a cross-sectional area of a portion of the second communication channel Q corresponding to a tube section of the liquid level box insertion tube 17 inserted into the communicating vessel insertion tube 341. For example, the minimum cross-sectional area S4 may be a cross-sectional area of the liquid level box insertion tube 17 inserted into the communicating vessel insertion tube 341.

In this way, during use of the water purifier 100, the liquid level inside the purified water tank 20 and the liquid level inside the liquid level box 10 can always remain completely consistent. The water level detected by the water level sensor 12 in the liquid level box 10 can reflect a real water level inside the purified water tank 20 in real time, thereby avoiding repeated water production.

As described above, the cross-sectional area S1 of the purified water tank inner cavity B along the height direction of the water purifier 100 and the cross-sectional area S3 of the liquid level box inner cavity A along the height direction of the water purifier 100 satisfy: S1>S3.

A bottom wall of the purified water tank inner cavity B is configured to be flush with a bottom wall of the liquid level box inner cavity A.

To be flush refers to that a bottom inner surface of the purified water tank 20 (i.e., a bottom wall of the purified water tank inner cavity B) and a bottom inner surface of the liquid level box 10 (i.e., a bottom wall of the liquid level box inner cavity A) are at the same horizontal height.

As described above, the cross-section of the purified water tank inner cavity B and the cross-section of the liquid level box inner cavity A remain unchanged along the height direction of the water purifier 100. In this way, the water level detected by the water level sensor 12 in the liquid level box 10 is the real water level inside the purified water tank 20.

In some embodiments, a cross-sectional area of the first communication port 32 is greater than a cross-sectional area of the second communication port 31.

In some embodiments, a cross-sectional area of the liquid level box communication port 11 is greater than or equal to 4.5 mm2; and/or a cross-sectional area of the purified water tank communication port 21 is greater than 40 mm2.

If the cross-sectional area of the liquid level box communication port 11 is too large, i.e., a diameter of the liquid level box communication port 11 is too large, the flow speed of water in the liquid level box 10 is relatively fast. This causes the water level inside the liquid level box 10 to drop too quickly, leading to an excessively fast drop of the liquid level inside the liquid level box 10. The liquid level inside the liquid level box 10 becomes lower than the liquid level inside the purified water tank 20, causing the water level detected by the water level sensor 12 to fail to reflect the real water level inside the purified water tank 20. When the cross-sectional area of the liquid level box communication port 11 is too small, i.e., the diameter of the liquid level box communication port 11 is too small, the flow speed of water in the liquid level box 10 is relatively slow. The water level inside the liquid level box 10 drops too slowly. Similarly, the water level detected by the water level sensor 12 fails to reflect the real water level inside the purified water tank 20.

When the cross-sectional area of the liquid level box communication port 11 is greater than or equal to 4.5 mm2, and/or the cross-sectional area of the purified water tank communication port 21 is greater than 40 mm2. This configuration ensures that the water from the liquid level box 10 enters and exits the communicating vessel 30 through the liquid level box communication port 11, and when the water from the liquid level box 10 enters and exits the communicating vessel 30 through the liquid level box communication port 11, rise and fall of the water level inside the liquid level box 10 and the water level inside the purified water tank 20 occur synchronously, so that a water level detection result detected by the water level sensor 12 in the liquid level box 10 can more accurately reflect the water level inside the purified water tank 20.

As described above, an outer wall of the housing 80 is provided with the supporting member 81. The purified water tank 20 is detachably disposed on the supporting member 81, such that the purified water tank 20 is mounted on the outer side of the housing 80.

The supporting member 81 refers to a component configured to support, place, or mount the purified water tank 20. For example, the supporting member 81 may be a base configured to support the purified water tank 20. As another example, the supporting member 81 may be a water collecting box 85 described below. Exemplary detachable connection manners include buckle connection, magnetic attraction connection, or the like. In addition, the purified water tank 20 may be directly placed on the supporting member 81.

Therefore, the purified water tank 20 is detachably disposed outside the housing 80, enabling the user to directly remove the purified water tank 20 to take water when a large amount of water is needed. In addition, the purified water tank 20 can be conveniently removed for maintenance operations such as cleaning.

Merely by way of example, the supporting member 81 is provided as the water collecting box 85. The water collecting box 85 is detachably disposed on the outer side of the housing 80, a top wall of the water collecting box 85 is provided with a water collecting opening 82 that communicates to an interior of the water collecting box 85, and the purified water tank 20 is supported on the top wall of the water collecting box 85. The water collecting opening 82 refers to a water inlet interface provided on the water collecting box 85. For example, the water collecting opening 82 may be a through hole provided on a top wall of the water collecting box 85. Dripping water may flow into the water collecting box 85 through the water collecting opening 82

In some embodiments, as shown in FIG. 10, FIG. 12, and FIG. 16, to enable communication between the purified water tank 20 and the communicating vessel 30, a communicating vessel check valve 36 and a purified water tank check valve 27 are provided at the first communication port 32 and the purified water tank communication port 21, respectively.

As described above, the communicating vessel 30 is provided with the communicating vessel connection tube 34 that communicates with the communicating vessel inner cavity C. The communicating vessel connection tube 34 is disposed at a position corresponding to the first communication port 32. For example, at least a portion of a structure of the communicating vessel 30 is disposed in the inner side of the housing 80. The communicating vessel connection tube 34 penetrates from inside the housing 80 to outside the housing 80 and extends to a supporting side of the supporting member 81.

In this way, a majority of the communicating vessel 30 is accommodated inside the housing 80, and only the communicating vessel connection tube 34 for connecting to the water purifier 100 extends outside the housing 80. The purified water tank 20 may be placed on the supporting member 81 outside the housing 80, facilitating the user access.

Correspondingly, the purified water tank 20 is provided with the purified water tank connection tube 22. The purified water tank connection tube 22 communicates with the purified water tank inner cavity B of the purified water tank 20. The purified water tank connection tube 22 is disposed at a position corresponding to the purified water tank communication port 21. The communicating vessel check valve 36 is located inside the communicating vessel connection tube 34. The purified water tank check valve 27 is disposed inside the purified water tank connection tube 22.

The communicating vessel check valve 36 refers to a valve mounted in the communicating vessel connecting tube 34. The purified water tank check valve 27 refers to a valve mounted in the purified water tank connection tube 22.

In some embodiments, the purified water tank connection tube 22 is configured to be inserted into the communicating vessel connection tube 34 when supported on the supporting member 81 to enable communication between the communicating vessel inner cavity C and the purified water tank inner cavity B. Merely by way of example, when the purified water tank connection tube 22 is inserted into the communicating vessel connection tube 34, the purified water tank check valve 27 pushes open a valve core 361 of the communicating vessel check valve to achieve water inflow/outflow between the communicating vessel 30 and the purified water tank 20.

In some embodiments, as shown in FIG. 10, FIG. 11 and FIG. 12, a valve seat 362 is provided inside the communicating vessel connection tube 34. The valve core 361 of the communicating vessel check valve is elastically connected to the valve seat 362. For example, the valve core 361 of the communicating vessel check valve is connected to the valve seat 362 through an elastic member. When the purified water tank connection tube 22 is inserted into the communicating vessel connection tube 34, a valve core 271 of the purified water tank check valve 27 overcomes an elastic force of the elastic member and abuts against the valve core 361 of the communicating vessel check valve to open the communicating vessel check valve 36. At the same time, the valve core 361 of the communicating vessel check valve also pushes open the valve core 271 of the purified water tank check valve to open the purified water tank check valve 27. When the purified water tank connection tube 22 is disengaged from the communicating vessel connection tube 34, the valve core 361 of the communicating vessel check valve returns to an original state under the action of the elastic member (not shown in the figure), thereby closing the communicating vessel connection tube 34. When the purified water tank connection tube 22 is disengaged from the communicating vessel connection tube 34, the valve core 271 of the purified water tank check valve also returns to an original state under the action of the elastic member, thereby closing the purified water tank connection tube 22.

Merely by way of example, a cross-sectional area of the valve core 361 of the communicating vessel check valve is less than or equal to a cross-sectional area of the valve core 271 of the purified water tank check valve.

In this way, when the purified water tank connection tube 22 is inserted into the communicating vessel connection tube 34, the valve core 271 of the purified water tank check valve can reliably abut against the valve core 361 of the communicating vessel check valve to smoothly open the communicating vessel check valve 36, thereby achieving water inflow/outflow from the communicating vessel 30 to the purified water tank 20.

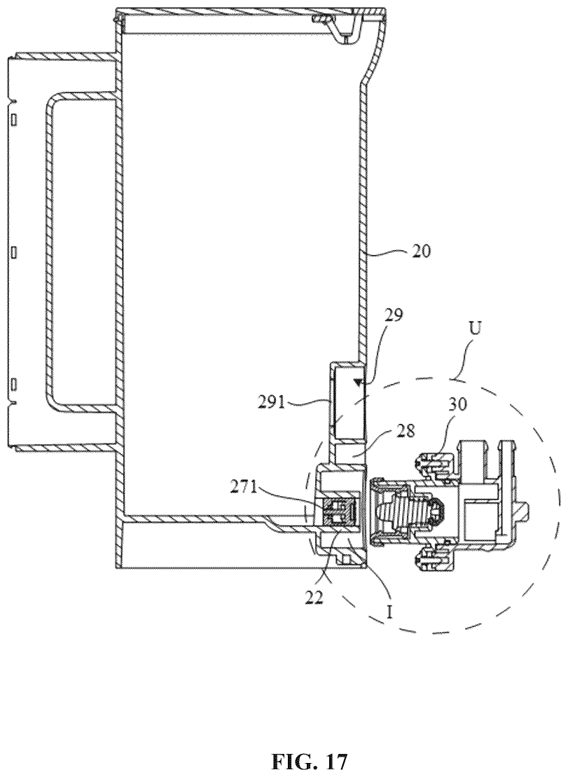

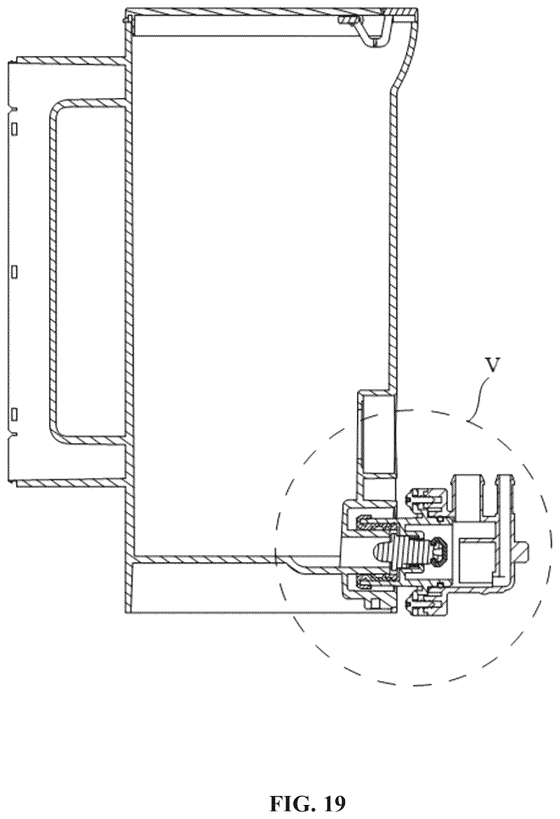

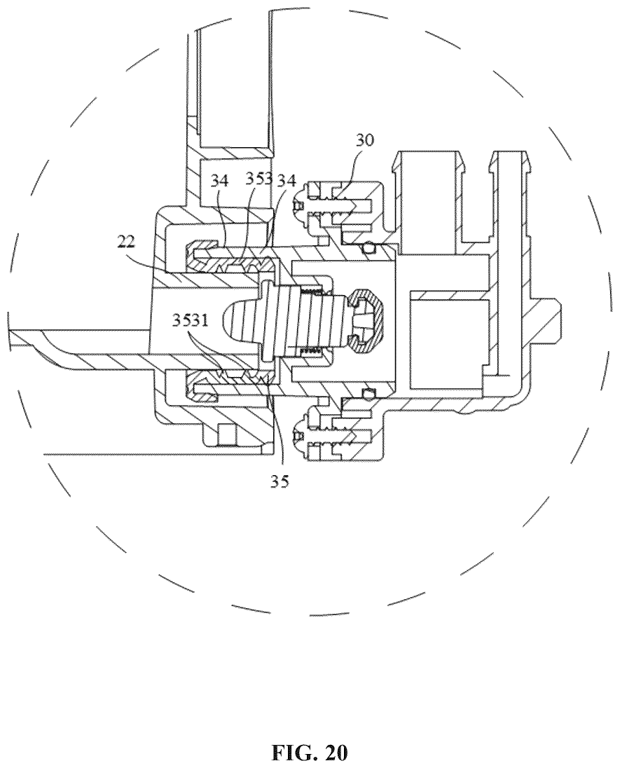

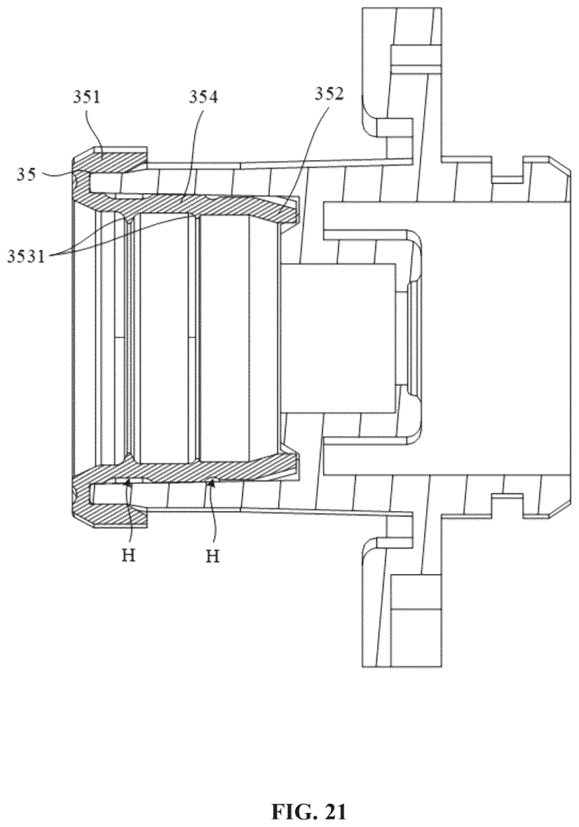

FIG. 17 is a schematic diagram illustrating a cross-sectional structure of a first communication port being separated from a purified water tank communication port of a water purifier according to some embodiments of the present disclosure. FIG. 18 is a partial enlarged view of a region U in FIG. 17. FIG. 19 is a schematic diagram illustrating a cross-sectional structure of a first communication port being mated with a purified water tank communication port of a water purifier according to some embodiments of the present disclosure. FIG. 20 is a partial enlarged view of a region V in FIG. 19. FIG. 21 is a schematic diagram illustrating a structure of a sealing ring being mated with a communicating vessel connection tube of a water purifier according to some embodiments of the present disclosure. It should be noted that, in FIG. 19 and FIG. 20, the structure of the purified water tank check valve is omitted for ease of observation.

As described above, as shown in FIG. 16, FIG. 17, FIG. 18, FIG. 19, and FIG. 20, an inner wall of the communicating vessel connection tube 34 is provided with the sealing ring 35. Two axial ends of the sealing ring 35 abut against the inner wall of the communicating vessel connection tube 34.

In some embodiments, a first sealing section 353 between the two axial ends of the sealing ring 35 and the inner wall of the communicating vessel connection tube 34 define a water storage chamber F.

In some embodiments, the purified water tank connection tube 22 is configured to be inserted into the communicating vessel connection tube 34 when supported on the supporting member 81 to enable communication between the communicating vessel inner cavity C and the purified water tank inner cavity B; cause the first sealing section 353 to elastically deform toward a radial outer side of the first sealing section 353 to squeeze water in the water storage chamber F into the communicating vessel connection tube 34; and when the purified water tank connection tube 22 is disengaged from the communicating vessel connection tube 34, cause the first sealing section 353 to elastically reset toward a radial inner side of the first sealing section 353 to adsorb water in the communicating vessel connection tube 34 into the water storage chamber F.

The sealing ring 35 may be used to prevent dripping during insertion and removal of the purified water tank connection tube 22. The sealing ring 35 may be made of an elastic material, e.g., rubber, silicone, or the like. This enables the sealing ring 35 to undergo elastic deformation during insertion and removal of the purified water tank connection tube 22 into and from the communicating vessel connecting tube 34.

The two axial ends of the sealing ring 35 refer to two ends of the sealing ring 35 along a central axis direction of the sealing ring 35. More descriptions regarding the sealing ring 35 may be found in the related descriptions below.

The first sealing section 353 refers to a region of the sealing ring 35 located between the two axial ends of the sealing ring 35.

The water storage chamber F refers to an annular water storage space between the first sealing section 353 and the communicating vessel connecting tube 34.

In the above solution, the water storage chamber F is defined by the first sealing section 353 between the two axial ends of the sealing ring 35 and the inner wall of a communicating vessel connection tube 34. The water storage chamber F has a certain water storage capacity. Since the purified water tank connection tube 22 may cause the first sealing section 353 to elastically reset toward the radial inner side of the first sealing section 353 when the purified water tank connection tube 22 is disengaged from the communicating vessel connection tube 34, the water in the communicating vessel connection tube 34 is adsorbed into the water storage chamber F. Therefore, when the user takes the purified water tank 20 and the purified water tank connection tube 22 is disengaged from the communicating vessel connection tube 34, even if water flows from the communicating vessel 30 into the communicating vessel connection tube 34, the water is partially or entirely adsorbed by the water storage chamber F. The problem of water flowing into the communicating vessel connection tube 34 due to the instantaneous disengagement of the purified water tank connection tube 22 and the communicating vessel connection tube 34 when the purified water tank 20 is taken is alleviated.

In some embodiments, as shown in FIG. 18 and FIG. 20, further, among the two axial ends of the sealing ring 35, an end portion facing the purified water tank 20 is defined as a first end portion 351, and an end portion away from the purified water tank 20 is defined as a second end portion 352.

The first end portion 351 is provided with an annular flange portion 3511. The flange portion 3511 and an outer peripheral side of the sealing ring 35 define a flange portion mounting groove G. An end portion of the communicating vessel connection tube 34 facing the purified water tank 20 is clamped into the flange portion mounting groove G, so that a portion of a structure of the first end portion 351 abuts against the inner wall of the communicating vessel connection tube 34.

In this way, the first end portion 351 of the sealing ring 35 wraps the end portion of the communicating vessel connection tube 34 facing the purified water tank 20. This prevents the water in the water storage chamber F from leaking out from the first end portion 351, i.e., the side of the sealing ring 35 facing the purified water tank 20.

In some embodiments, the second end portion 352 is provided with an annular protrusion portion 3521. The protrusion portion 3521 abuts against the inner wall of the communicating vessel connection tube 34. The protrusion portion 3521, an outer peripheral side of the first sealing section 353, and the flange portion 3511 jointly define a water storage recess. The water storage recess and the inner wall of the communicating vessel connection tube 34 jointly define the water storage chamber F.

In this way, the water storage chamber F is formed by providing the water storage recess on the sealing ring 35. The structure is relatively simple and facilitates processing. Moreover, this also facilitates inserting the purified water tank connection tube 22 into the inner side of the sealing ring 35, which presses the inner peripheral surface of the sealing ring 35 in a radially outward direction, causing the first sealing section 353 to elastically deform toward the radial outer side of the first sealing section 353 to squeeze the water in the water storage chamber F into the communicating vessel connection tube 34.

As described above, as shown in FIG. 18, the inner peripheral surface of the first sealing section 353 between the two axial ends of the sealing ring 35 is convexly provided with at least two interference fit portions 3531, which are annular in shape. The at least two interference fit portions 3531 are arranged along an axial direction of the sealing ring 35. The at least two interference fit portions 3531 are used for interference fit with the purified water tank connection tube 22.

The inner peripheral surface of the first sealing section 353 refers to an inner side surface of the first sealing section 353 that is close to a central hole of the first sealing section 353 along a radial direction of the first sealing section 353.

The outer peripheral surface of the first sealing section 353 refers to an outer side surface of the first sealing section 353 that is away from the central hole of the first sealing section 353 along the radial direction of the first sealing section 353.

The inner side of the sealing ring 35 refers to an inner side surface of the sealing ring 35 that is close to a central hole of the sealing ring 35 along the radial direction of the first sealing section 353.

The interference fit portion 3531 refers to a structure on the first sealing section 353 that achieves a sealed connection with the purified water tank connection tube 22 through interference fitting. For example, the interference fit portion 3531 is a protrusion disposed around the inner peripheral surface of the first sealing section 353. The at least two interference fit portions 3531 are spaced apart from each other by a certain distance along a central axis direction of the sealing ring 35.

In this way, when the purified water tank connection tube 22 is inserted into the communicating vessel connection tube 34, the purified water tank connection tube 22 may be in sealing engagement with the sealing ring 35, thereby preventing water from leaking between the purified water tank connection tube 22 and the communicating vessel connection tube 34.

In some embodiments, along a direction from the first end portion 351 toward the second end portion 352, protrusion heights of the at least two interference fit portions 3531 from the inner peripheral side of the sealing ring 35 gradually decrease.

The direction from the first end portion 351 toward the second end portion 352 is a direction in which the purified water tank connection tube 22 is inserted into the communicating vessel connection tube 34. During the insertion process, the purified water tank connection tube 22 first contacts the interference fit portion 3531 with a higher protrusion height, and water may be sealed as soon as possible to avoid leakage. With continued insertion, the purified water tank connection tube 22 cooperates with the interference fit portion 3531 with a lower protrusion height, and an interference amount is relatively small. The insertion difficulty of the purified water tank connection tube 22 can be reduced, and the insertion feel can be improved.

FIG. 21 is a schematic diagram illustrating a structure of a sealing ring being mated with a communication component connecting tube of a water purifier according to some embodiments of the present disclosure.

In some embodiments, as shown in FIG. 21, a count of the at least two interference fit portions 3531 is two. A support protrusion 354 is provided between regions on the outer peripheral side of the sealing ring 35 corresponding to the two interference fit portions 3531.

The outer peripheral surface of the sealing ring 35 refers to an outer side surface of the sealing ring 35 that is away from the central hole of the sealing ring 35 along the radial direction of the sealing ring 35.

In the embodiment, along the radial direction of the sealing ring 35, each of the two interference fit portions 3531 has a projection region on the outer peripheral surface of the sealing ring 35. In the axial direction of the sealing ring 35, the support protrusion 354 is located between the two projection regions.

In this way, when the purified water tank connection tube 22 is inserted into the inner side of the sealing ring 35, the two interference fit portions 3531 elastically deform toward the inner wall of the communicating vessel connection tube 34 under the pressure from the purified water tank connection tube 22. The support protrusion 354 first contacts the inner wall of the communicating vessel connection tube 34. At this time, two avoidance spaces are formed between the regions of the outer peripheral side of the sealing ring 35 corresponding to the two interference fit portions 3531 and the inner wall of the communicating vessel connection tube 34. The two avoidance spaces allow the two interference fit portions 3531 to still have room for elastic deformation radially outward or radially inward. This prevents a mismatch between the purified water tank connection tube 22 and the sealing ring 35 caused by dimensional tolerances, and addresses the issue of poor insertion feel during the insertion process of the purified water tank connection tube 22.

In some embodiments, the count of the at least two interference fit portions 3531 is two. Avoidance grooves H are respectively disposed on the regions of the outer peripheral side of the sealing ring 35 corresponding to the two interference fit portions 3531. A groove depth of the avoidance groove H corresponding to the interference fit portion 3531 with a higher protrusion height is greater than a groove depth of the avoidance groove H corresponding to the interference fit portion 3531 with a lower protrusion height.

In this way, the interference fit portion 3531 with the higher protrusion height has a larger avoidance space, and the interference fit portion 3531 with the lower protrusion height has a smaller avoidance space. Such differentiated design allows the capacity of the water storage chamber F to be as large as possible.

As shown in FIG. 10, FIG. 16, and FIG. 20, when the purified water tank connection tube 22 of the purified water tank 20 is inserted into the communicating vessel connection tube 34, the valve core 271 of the purified water tank check valve abuts against the valve core 361 of the communicating vessel check valve. The communicating vessel check valve 36 opens, so that the purified water tank inner cavity B of the purified water tank 20 communicates with the communicating vessel inner cavity C of the communicating vessel 30. At this time, the purified water tank connection tube 22 is inserted into the inner side of the sealing ring 35 and pushes the first sealing section 353 toward the radial outer side of the sealing ring 35. This causes the outer side wall of the first sealing section 353 to abut against the inner wall of the communicating vessel connection tube 34, thereby squeezing the water storage chamber F. During the process of withdrawing the purified water tank connection tube 22 from the communicating vessel connection tube 34, a portion of water may flow out from the valve core 361 of the communicating vessel check valve. At this time, the squeezing of the communicating vessel connection tube 34 on the first sealing section 353 disappears, the sealing ring 35 recovers, and the water storage chamber F returns to an original state. The portion of water that flows into the communicating vessel connection tube 34 is squeezed into the water storage chamber F due to atmospheric pressure and temporarily stored in the water storage chamber F.

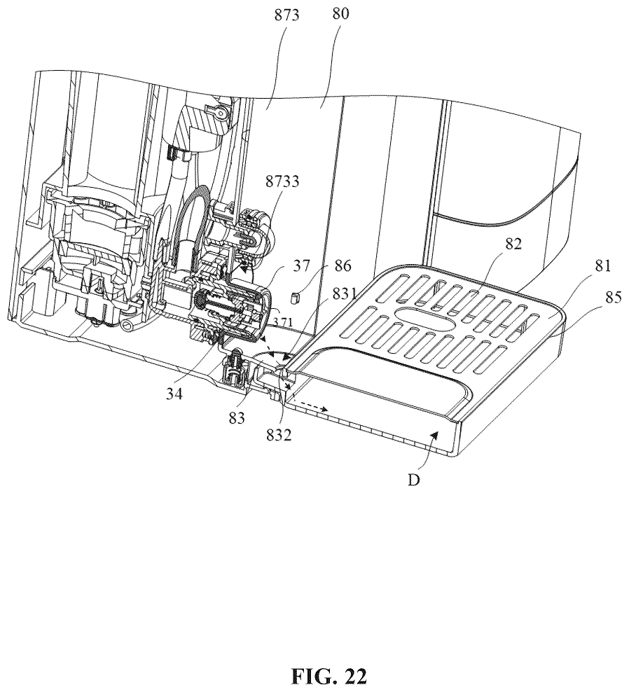

FIG. 22 is a schematic diagram illustrating a structure of a supporting member being connected to a housing of a water purifier according to some embodiments of the present disclosure.

In some embodiments, as shown in FIG. 22, as described above, the supporting member 81 is detachably connected to the housing 80. For example, the supporting member 81 is connected to the front panel 873. The supporting member 81 is provided with a water collecting chamber D. A top wall of the supporting member 81 is provided with the water collecting opening 82 communicating with the water collecting chamber D. The purified water tank 20 is supported on the top wall of the supporting member 81.

In this way, water leaking from a connection between the purified water tank 20 and the communicating vessel 30 may enter the water collecting chamber D through the water collecting opening 82. Alternatively, the user may place a water cup on the supporting member 81. Water outside the water cup or outside the purified water tank 20 may be poured into the water collecting chamber D through the water collecting opening 82.

In some embodiments, the outer wall of the housing 80 is provided with a water guiding portion 83. The supporting member 81 is detachably connected to the housing 80 via plug-in engagement with the water guiding portion 83.

The water guiding portion 83 has a guiding surface 831. A guiding hole 832 communicating with the water collecting chamber D is provided on the guiding surface 831. The guiding surface 831 is configured to guide water in the communicating vessel connection tube 34 to the guiding hole 832.

In this way, as shown by the dashed lines in FIG. 22, the water in the communicating vessel connection tube 34 may be guided to the guiding hole 832 by the water guiding portion, and the water in the communicating vessel connection tube 34 may finally flow into the water collecting chamber D. The user may periodically remove the supporting member 81 and clean water in the water collecting chamber D.

In some embodiments, to better guide water flowing out from the communicating vessel connection tube 34, a projection of the end portion of the communicating vessel connection tube 34 facing the purified water tank 20 on a first plane is within a range of a projection of the guiding surface 831 on the first plane. The first plane is perpendicular to the height direction of the water purifier 100. In this way, when water leaks from the end portion of the communicating vessel connection tube 34 and falls under gravity, the water may be completely caught by the guiding surface 831 and collected into the water collecting chamber D. For example, the guiding surface 831 is configured as a conical surface centered on the guiding hole 832. An inclined conical surface provides a good effect of water guiding.

In some embodiments, a through hole 8733 for the communicating vessel connection tube 34 to penetrate through is provided on the housing 80. The communicating vessel 30 further includes a pressing cover 37. The pressing cover 37 is connected to an edge of an opening of the through hole 8733. The pressing cover 37 is provided with a pressing cover opening 371 for the purified water tank connection tube 22 to be inserted into the communicating vessel connection tube 34. The pressing cover 37 presses the end portion of the sealing ring 35 facing the purified water tank 20 against the communicating vessel connection tube 34.

In this way, the sealing ring 35 can be more reliably fixed on the communicating vessel connection tube 34. For example, an end portion of the pressing cover 37 is provided with an inwardly bent bending portion. A top end portion of the bending portion presses tightly against the sealing ring 35.

Correspondingly, as shown in FIG. 17, an outer wall of the purified water tank 20 is provided with a purified water tank mounting groove 28. The purified water tank connection tube 22 is disposed on a bottom wall of the purified water tank mounting groove 28. An accommodation space I is defined between an outer wall of the purified water tank connection tube 22 and a side groove wall of the purified water tank mounting groove 28. The accommodation space I is used for accommodating the pressing cover 37. In this way, a surface of the purified water tank 20 is relatively flat, and the structure is aesthetically pleasing.

In some embodiments, as shown in FIG. 9 and FIG. 22, to detect whether the purified water tank 20 is located on the supporting member 81, the water purifier 100 further includes a sensor assembly 86. The sensor assembly 86 is disposed inside the housing 80. The sensor assembly 86 is configured to detect a relative position between the purified water tank 20 and the supporting member 81.

Regarding a setting position of the sensor assembly 86, for example, the sensor assembly 86 may be disposed at an inner side of the housing 80, so that a detection end of the sensor assembly 86 penetrates from inside the housing 80 to outside the housing 80 and extends to a supporting side of the supporting member 81. To trigger the sensor assembly 86, a triggering portion 861 is disposed at a position on the outer wall of the purified water tank 20 corresponding to the detection end. The triggering portion 861 is configured to contact the detection end when the purified water tank 20 is supported on the supporting member 81, o trigger the sensor assembly 86 to perform detection. In this way, determining whether the purified water tank 20 is located on the supporting member 81 is facilitated.

Merely by way of example, the sensor assembly 86 may be a micro switch. When the purified water tank 20 is placed on the supporting member 81, the triggering portion 861 triggers the detection end of the sensor assembly 86 to detect that the purified water tank 20 is in place.

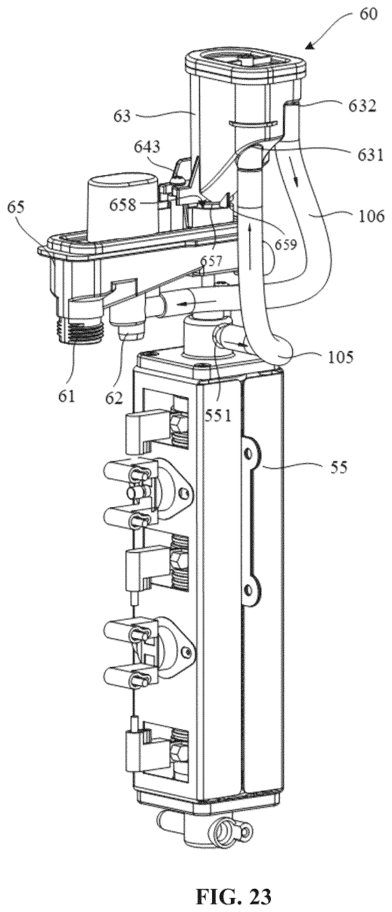

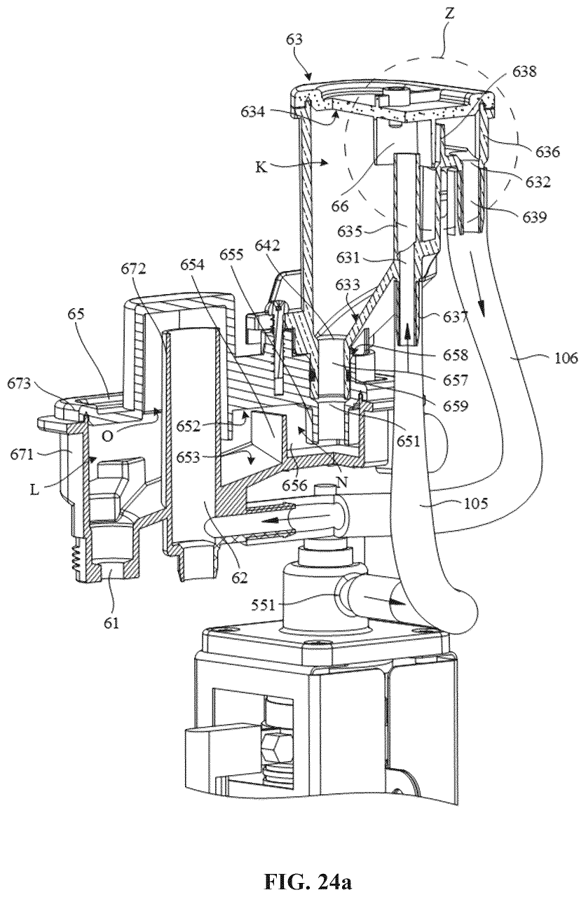

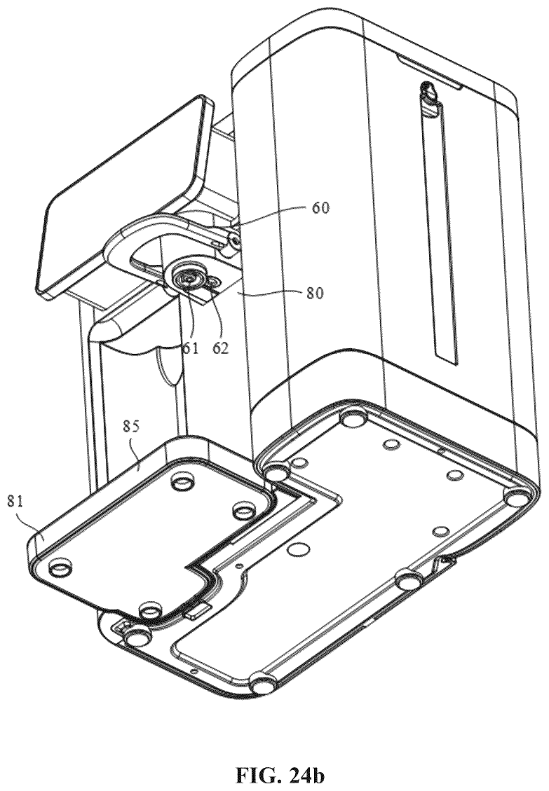

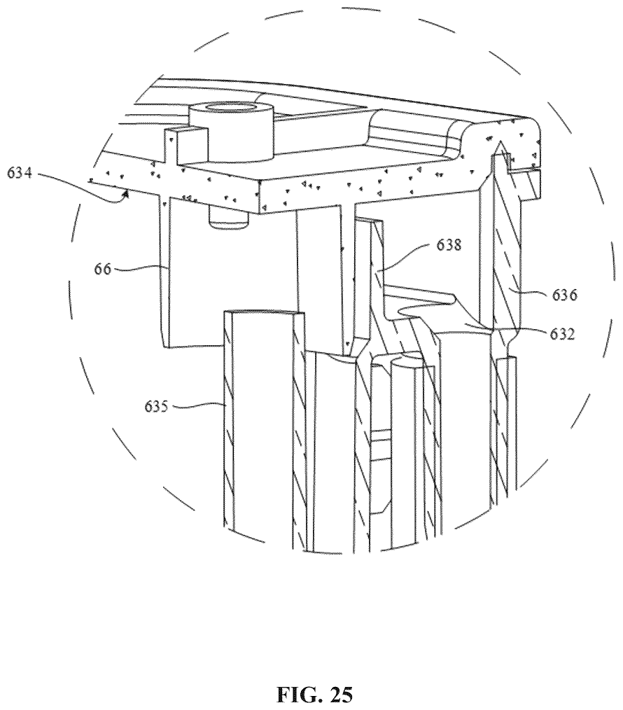

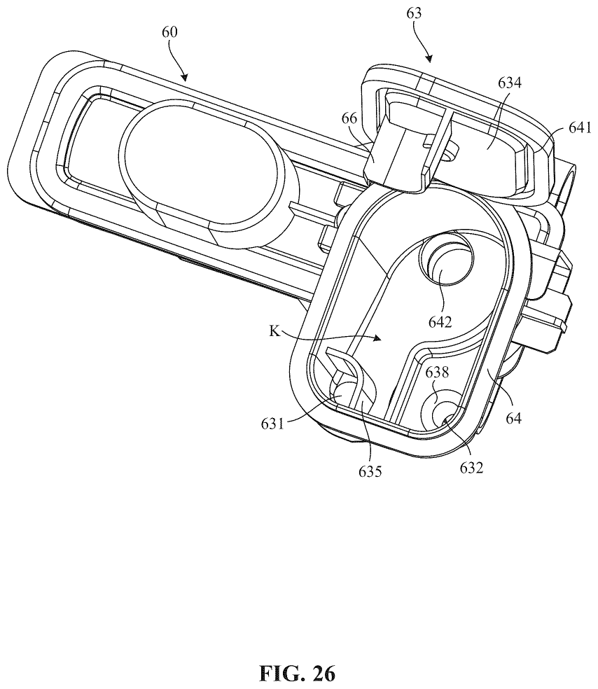

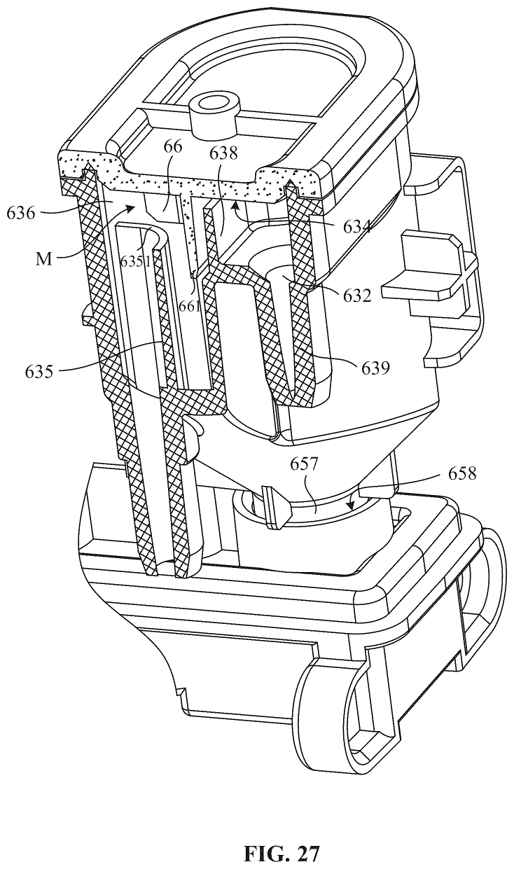

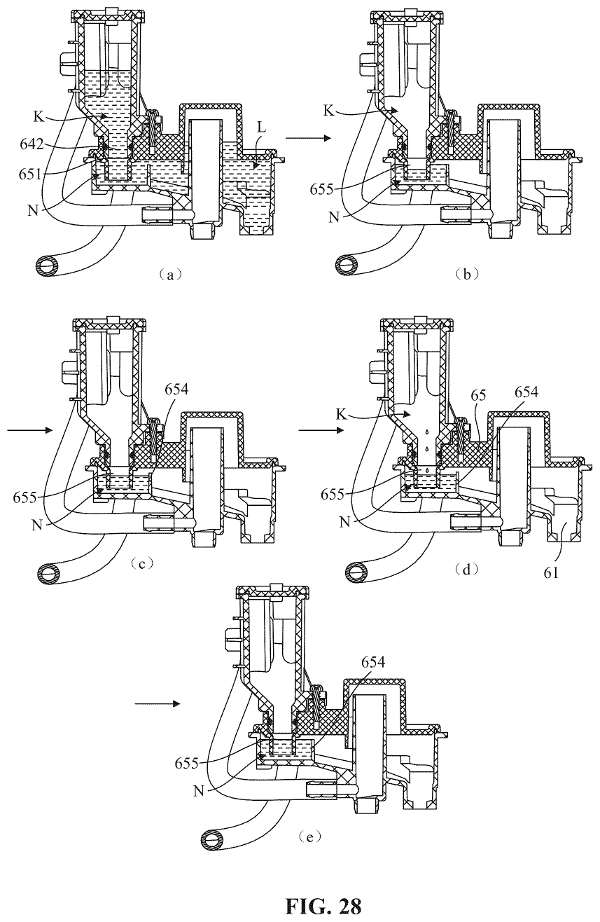

FIG. 23 is a schematic diagram illustrating a structure of a water vapor separator according to some embodiments of the present disclosure. FIG. 24a is a schematic diagram illustrating a cross-sectional structure of a water vapor separator according to some embodiments of the present disclosure. FIG. 24b is a schematic diagram illustrating a structure of a water purifier from another perspective according to some embodiments of the present disclosure. FIG. 25 is a partial enlarged view of a region Z in FIG. 24a. FIG. 26 is a schematic diagram illustrating a structure of a water vapor separator from another perspective according to some embodiments of the present disclosure. FIG. 27 is a partial cross-sectional view of a water vapor separator according to some embodiments of the present disclosure. FIG. 28 is a cross-sectional view of a water vapor separator from another perspective according to some embodiments of the present disclosure. It should be understood that, to facilitate observation of internal structures, FIG. 26 shows a schematic diagram of a state where a first-stage separation body cover 641 is opened relative to a first-stage separation body 64.

As mentioned above, the water vapor separator 60 is used for separating steam from heated purified water. The water vapor separator 60 is provided with the water vapor separator water outlet 61. The water vapor separator water outlet 61 forms a water taking port of the water purifier 100.

In water vapor separators of related technologies, the problem of poor separation effect on steam exists. Water flowing out from the water vapor separator water outlet contains a large amount of steam. To avoid this problem, water purifiers of related technologies often control an outlet water temperature at about 93° C. to reduce the steam in the outlet water. Accordingly, the water purifiers of related technologies have the problem of insufficiently high outlet water temperature.

To solve this problem, the embodiment of the present disclosure improves the structure of the water vapor separator 60.

In some embodiments, as shown in FIG. 23, FIG. 24a, and FIG. 25, the water vapor separator 60 includes a first-stage water vapor separation body 63 and a second-stage water vapor separation body 65 for performing water vapor separation. The first-stage water vapor separation body 63 and the second-stage water vapor separation body 65 are respectively provided with a first-stage water vapor separation cavity K and a second-stage water vapor separation cavity L that communicate with each other.

The first-stage water vapor separation body 63 is provided with a water vapor separator water inlet 631 and a first air outlet 632 that communicate to the first-stage water vapor separation cavity K. The water vapor separator water outlet 61 and the water vapor separator air outlet 62 are provided on the second-stage water vapor separation body 65 and communicate to the second-stage water vapor separation cavity L. The water vapor separator water inlet 631 is configured to be connected to a hot water supply source.

The water vapor separator water inlet 631 is provided on a bottom wall 633 of the first-stage water vapor separation cavity. The bottom wall 633 of the first-stage water vapor separation cavity is provided with a first guide tube 635 extending toward a top wall 634 of the first-stage water vapor separation cavity. The first guide tube 635 communicates to the water vapor separator water inlet 631. The top wall 634 of the first-stage water vapor separation cavity is further provided with a guide wall 66 extending toward the bottom wall 633 of the first-stage water vapor separation cavity. The guide wall 66 abuts against a peripheral outer side of at least a portion of a tube segment of the first guide tube 635.

The water vapor separator 60 includes the first-stage water vapor separation body 63 and the second-stage water vapor separation body 65 for performing water vapor separation, and the first-stage water vapor separation cavity K in the first-stage water vapor separation body 63 and the second-stage water vapor separation cavity L in the second-stage water vapor separation body 65 communicate with each other. In this way, a water vapor mixture first enters the first-stage water vapor separation body 63 for first water vapor separation, and then enters the second-stage water vapor separation body 65 for second water vapor separation, achieving better water vapor separation effect.

In addition, the water vapor separator water inlet 631 is disposed on the bottom wall 633 of the first-stage water vapor separation cavity, and the bottom wall 633 of the first-stage water vapor separation cavity is provided with the first guide tube 635 extending toward the top wall 634 of the first-stage water vapor separation cavity. In this way, the water vapor mixture entering the first-stage water vapor separation cavity K from the water vapor separator water inlet 631 enters the first guide tube 635. In addition, the top wall 634 of the first-stage water vapor separation cavity is provided with the guide wall 66 extending toward the bottom wall 633 of the first-stage water vapor separation cavity. The guide wall 66 is disposed on the peripheral outer side of the at least a portion of the tube segment of the first guide tube 635. In this way, after the water vapor mixture in the first guide tube 635 leaves the first guide tube 635, the water vapor mixture rushes toward the top wall 634 of the first-stage water vapor separation cavity. The top wall 634 of the first-stage water vapor separation cavity may disperse the water vapor mixture to separate a portion of steam in the water vapor mixture from water flow. The water flow flows down along the guide wall 66 into a bottom of the first-stage water vapor separation cavity K. The steam flows upward and is discharged from the first-stage water vapor separation body 63 through the first air outlet 632. As described above, in a case where the water vapor separation effect is good, the steam in the water is less, and the outlet water temperature of the water purifier can be set higher to meet water usage demand of the user.

The hot water supply source may be the heater 55. A water outlet 551 of the heater may be connected to the water vapor separator water inlet 631 through a fifth pipeline 105. In other embodiments, the water outlet 551 may be directly connected to the water vapor separator water inlet 631.

In the embodiments, a setting height of a bottom end portion of the guide wall 66 facing the bottom wall 633 of a first-stage water vapor separation cavity is lower than a setting height of a top end portion of the first guide tube 635 facing the first-stage water vapor separation cavity K.

By making the bottom end portion of the guide wall 66 lower than the top end portion of the first guide tube 635, water flow dispersed after the water vapor mixture out from the first guide tube 635 is dispersed by the top wall 634 of the first-stage water vapor separation cavity reliably falls onto the bottom wall 633 of the first-stage water vapor separation cavity along the guide wall 66, and the water flow does not enter the first guide tube 635 from the top end portion of the first guide tube 635.

In some embodiments, as shown in FIG. 27, the guide wall 66 and a portion of a side wall 636 of the first-stage water vapor separation cavity define a dispersing cavity M. A portion of a tube segment on a top side of the first guide tube 635 extends into the dispersing cavity M.

In some embodiments, at least a portion of an outer tube wall of the first guide tube 635 and an inner wall of the first-stage water vapor separation cavity K are configured as an integral component, which facilitates the processing and manufacturing process.

In some embodiments, as shown in FIG. 24a and FIG. 27, an outer wall of the first-stage water vapor separation body 63 is provided with a first mounting tube 637 coaxial with the first guide tube 635 and communicating with the first guide tube 635. In this way, the water vapor mixture flowing out from the water outlet 551 of the heater can be conveniently guided into the first guide tube 635.

In some embodiments, the first air outlet 632 is disposed on the side wall 636 of the first-stage water vapor separation cavity. The side wall 636 of the first-stage water vapor separation cavity is provided with a second guide tube 638 extending toward the top wall 634 of the first-stage water vapor separation cavity. The second guide tube 638 communicates with the first air outlet 632. The guide wall 66 extends between the first guide tube 635 and the second guide tube 638. The top end portion of the first guide tube 635 and a top end portion of the second guide tube 638 are separated by the guide wall 66.

With such a configuration, a setting height of the bottom end portion of the guide wall 66 is actually lower than a setting height of the top end portion of the second guide tube 638. After the water vapor mixture out from the first guide tube 635 is dispersed by the top wall 634 of the first-stage water vapor separation cavity, the water flow flows downward on a side of the guide wall 66 facing the first guide tube 635. Due to the shielding of the guide wall 66, the water flow may not enter the second guide tube 638.

Similar to the first guide tube 635, at least a portion of an outer tube wall of the second guide tube 638 and the inner wall of the first-stage water vapor separation cavity K are configured as an integral component, which facilitates the processing and manufacturing.

In the embodiments, the outer wall of the first-stage water vapor separation body 63 is provided with a second mounting tube 639 coaxial with the second guide tube 638 and communicating with the second guide tube 638. In this way, steam after water vapor separation can be conveniently guided out of the first-stage water vapor separation cavity K. For example, as shown in FIG. 24a, the second mounting tube 639 may communicate with the water vapor separator air outlet 62 on the second-stage water vapor separation body 65 through a sixth pipeline 106.

In some embodiments, as shown in FIG. 26 and FIG. 27, the first-stage water vapor separation body 63 includes a first-stage separation body 64 and a first-stage separation body cover 641 disposed on the first-stage separation body 64. The guide wall 66 is disposed on the first-stage separation body cover 641. Such a configuration can facilitate the processing procedure.

In some embodiments, as shown in FIG. 24a, FIG. 27, and FIG. 28, the first-stage water vapor separation body 63 is provided with a first connection port 642 communicating with the first-stage water vapor separation cavity K. The second-stage water vapor separation body 65 is provided with a second connection port 651 communicating with the second-stage water vapor separation cavity L. The first connection port 642 communicates with the second connection port 651.

A top wall 652 of the second-stage water vapor separation cavity is provided with a third guide tube 655 extending toward a bottom wall 653 of the second-stage water vapor separation cavity. The third guide tube 655 communicates with the second connection port 651. The bottom wall 653 of the second-stage water vapor separation cavity is provided with a stop wall 654 extending toward the top wall 652 of the second-stage water vapor separation cavity. The stop wall 654 is positioned to block a region between an outer peripheral side of the third guide tube 655 and the water vapor separator water outlet 61.

With the above design, water flowing out from the first-stage water vapor separation cavity K falls onto the bottom wall 653 of the second-stage water vapor separation cavity and is dispersed again to separate a portion of the steam mixed in the water flow from the water flow. The bottom wall 653 of the second-stage water vapor separation cavity is provided with the stop wall 654 extending toward the top wall of the second-stage water vapor separation cavity. The stop wall 654 is positioned to block the region between the outer peripheral side of the third guide tube 655 and the water vapor separator water outlet 61. In this way, the water flow after being dispersed and separated on the bottom wall 653 of the second-stage water vapor separation cavity encounters the stop wall 654 during the flow toward the water vapor separator water outlet 61 and is dispersed again for water vapor separation. The separated steam flows out of the second-stage water vapor separation cavity L from the water vapor separator air outlet 62. The water flow dispersed again by the stop wall 654 contains a relatively low amount of steam and may flow out of the second-stage water vapor separation cavity L through the water vapor separator water outlet 61. In this way, the water flow entering the second-stage water vapor separation cavity L undergoes two more water vapor separations. Combined with the use of the first-stage water vapor separation body 63, the water vapor separation effect for hot water reaches a relatively optimal degree.

In some embodiments, as shown in FIG. 24a and FIG. 28, further, the bottom wall 653 of the second-stage water vapor separation cavity is provided with a retention groove N spaced apart from the water vapor separator water outlet. A bottom end portion of the third guide tube 655 extends into the retention groove N.

By making the bottom end portion of the third guide tube 655 extend into the retention groove N, a height of the bottom end portion of the third guide tube 655 is lower than a height of a groove edge portion of the retention groove N. In this way, at the moment water taking stops, water flowing out from the first-stage water vapor separation cavity K may rush out of the third guide tube 655 due to water flow inertia and water adhesion characteristics, causing a water level inside the third guide tube 655 to be lower than a water level inside the retention groove N (which is filled with water). As time passes and the water in the third guide tube 655 gradually stabilizes, a portion of the water in the retention groove N returns to the third guide tube 655, causing the water level inside the third guide tube 655 to equalize with the water level inside the retention groove N. Consequently, the water level inside the retention groove N is lower than the groove edge portion and is not fully filled. At this time, if residual water droplets in the first-stage water vapor separation cavity K fall into the second-stage water vapor separation body 65, the water level inside the retention groove N and the water level inside the third guide tube 655 may rise accordingly. However, due to the viscosity of water, water may adhere to side groove walls of the retention groove N, i.e., water in the retention groove N may not flow out. Accordingly, no water droplets may fall from the water vapor separator water outlet 61. In this way, a quick water sealing effect is achieved when water taking stops, thereby effectively improving the problem of water leakage at the water taking port of the water purifier 100.

Air may easily enter an inner cavity of the water vapor separator 60 from the water vapor separator water outlet 61. Over time, bacteria may easily breed. Furthermore, the inner cavity is a region that the user cannot clean. In view of this, by providing the retention groove N, after water taking stops, the bottom end portion of the third guide tube 655 extends into the retention groove N to serve as a liquid seal. In this way, external air may be prevented from entering the inner cavity of the water vapor separator 60, particularly the first-stage water vapor separation body 63. Bacterial growth can be inhibited, making water output from the water vapor separator 60 cleaner and more hygienic.

In some embodiments, the stop wall 654 and a portion of a side wall 656 of the second-stage water vapor separation cavity define the retention groove N. With such a configuration, compared to forming a groove on the bottom wall 653 of the second-stage water vapor separation cavity, the volume of the second-stage water vapor separation body 65 can be relatively small.

In some embodiments, as shown in FIG. 23 and FIG. 24a, an outer wall of the first-stage water vapor separation body 63 is provided with a first mating tube 657 communicating with the first connection port 642. The second-stage water vapor separation body 65 is provided with a first mating insertion slot 658 communicating with the second connection port 651. The first mating tube 657 and the first mating insertion slot 658 are engaged in an insertion fit manner, so that the first connection port 642 communicates with the second connection port 651.

It should be understood that, to prevent water leakage between the first mating tube 657 and the first mating insertion slot 658, a sealing member 660 may be provided between an outer wall of the first mating tube 657 and an inner slot wall of the first mating insertion slot 658. The sealing member 660 may be an annular sealing ring that sleeves an outer periphery of the first mating tube 657 and is clamped between the first mating tube 657 and the first mating insertion slot 658.

In this way, the first-stage water vapor separation body 63 and the second-stage water vapor separation body 65 are engaged in the insertion fit manner, making the cooperation between the first-stage water vapor separation body 63 and the second-stage water vapor separation body 65 relatively secure. It should be understood that, as shown in FIG. 23, the first-stage water vapor separation body 63 and the second-stage water vapor separation body 65 may be fixedly connected by a fastener 643, making the connection between the first-stage water vapor separation body 63 and the second-stage water vapor separation body 65 more secure. A plurality of positioning ribs 659 arranged at intervals in a circumferential direction may be provided on an outer peripheral wall of the first mating tube 657. The plurality of positioning ribs 659 abut against a slot opening of the first mating insertion slot 658 to assist in positioning the insertion fit between the first mating tube 657 and the first mating insertion slot 658.

As shown in FIG. 23 and FIG. 24a, further, the second-stage water vapor separation body 65 includes a second-stage water vapor separation body 671 and a second-stage water vapor separation cover 673 disposed on the second-stage water vapor separation body 671. The first mating insertion slot 658 is disposed on a top side of the second-stage water vapor separation cover 673. The third guide tube 655 is disposed on a bottom side of the second-stage water vapor separation cover 673 and communicates with the first mating insertion slot 658.

In this way, after the first mating tube 657 is inserted into the first mating insertion slot 658, water flowing out from the first mating tube 657 may directly enter the third guide tube 655. For example, the first mating tube 657 and the third guide tube 655 may be arranged coaxially.

In some embodiments, the water vapor separator water outlet 61 is disposed on the bottom wall 653 of the second-stage water vapor separation cavity. The bottom wall 653 of the second-stage water vapor separation cavity is provided as an inclined wall structure inclined toward the water vapor separator water outlet 61. In this way, water flowing out from the retention groove N can more easily flow into the water vapor separator water outlet 61 along the inclined wall.

In some embodiments, as shown in FIG. 24a and FIG. 27, further, the water vapor separator air outlet 62 is disposed on the bottom wall 653 of the second-stage water vapor separation cavity and located between the water vapor separator water outlet 61 and the stop wall 654.

The bottom wall 653 of the second-stage water vapor separation cavity is provided with a fourth guide tube 672 extending toward the top wall 652 of the second-stage water vapor separation cavity. The fourth guide tube 672 communicates with the water vapor separator air outlet 62. A top end portion of the fourth guide tube 672 is spaced apart from the top wall 652 of the second-stage water vapor separation cavity.

In this way, steam separated in the second-stage water vapor separation cavity L rises and gathers at a top of the second-stage water vapor separation cavity L. The steam may enter the fourth guide tube 672 from the top end portion of the fourth guide tube 672 and flow out of the second-stage water vapor separation cavity L from the water vapor separator air outlet 62.

In some embodiments, the water vapor separator air outlet 62 is located at a position of the bottom wall 653 of the second-stage water vapor separation cavity close to the water vapor separator water outlet 61.

In the embodiments of the present disclosure, an inner side wall of the second-stage water vapor separation cover 673 is provided with an avoidance recess O at a position corresponding to the fourth guide tube 672. The top end portion of the fourth guide tube 672 extends into the avoidance recess O.

In this way, even if the fourth guide tube 672 is relatively long, an external contour size of the second-stage water vapor separation body 65 is not increased.

In some embodiments, the water vapor separator air outlet 62 is located between the water vapor separator water outlet 61 and the second connection port 651. The position of the first connection port 642 corresponds to the position of the second connection port 651.

Further, the water vapor separator water outlet 61, the water vapor separator air outlet 62, and the first connection port 642 are arranged in a row.

As shown in FIG. 24b, as described above, an outer wall of the housing 80 is provided with the supporting member 81. The water collecting box 85 is formed on the supporting member 81. During water taking, the user may place a water taking container on the water collecting box 85 to take water from the position of the water vapor separator water outlet 61. A setting position of the water vapor separator 60, particularly the water vapor separator water outlet 61 and the water vapor separator air outlet 62, needs to be located above the supporting member 81 (the water collecting box 85) and correspond to the position of the supporting member 81.

As mentioned earlier, an avoidance notch needs to be provided on the housing 80 to allow a portion of the structure of the water vapor separator 60 to be exposed to the outer side of the housing 80. For example, the water vapor separator water outlet 61 and the water vapor separator air outlet 62 need to be located on the outer side of the housing 80, which facilitates water taking, and facilitates air exhausting without air entering the interior of the housing 80 to affect various components inside the housing 80.

In some embodiments, the first connection port 642 is disposed on the bottom wall 633 of the first-stage water vapor separation cavity. The bottom wall 633 of the first-stage water vapor separation cavity is provided as an inclined structure inclined toward the first connection port 642. In this way, water flow flowing downward from the guide wall 66 can more easily flow out of the first-stage water vapor separation cavity K from the first connection port 642. As described above, the water vapor separator liquid inlet 631 and the first connection port 642 are both located on the bottom wall 633 of the first-stage water vapor separation cavity. However, the setting position of the water vapor separator liquid inlet 631 is higher than the setting position of the first connection port 642. This facilitates fluid flowing out from the first guide tube 635 to be more easily guided to the first connection port 642 from the bottom wall 633 of the first-stage water vapor separation cavity.

In addition, as described above, the water vapor separator air outlet 62 may communicate with the interior of the filter housing 42. In this way, steam discharged from the water vapor separator air outlet 62 may be discharged to the atmosphere through the filter housing 42. As another example, a portion of the structure of the water vapor separator 60 may be arranged inside the housing 80, and both the water vapor separator water outlet 61 and the water vapor separator air outlet 62 may be disposed outside the housing 80. Such a configuration facilitates steam discharged from the water vapor separator air outlet 62 to dissipate to the outer side of the housing.

In some embodiments, a cross-sectional area of the water vapor separator air outlet 62 is greater than or equal to 22 mm2. Since steam discharged from the water vapor separator air outlet 62 forms condensate upon contacting outside air, and the condensate may directly flow into an external water cup. When the cross-sectional area of the water vapor separator air outlet 62 is too small, the condensate may form a water film when penetrating through the water vapor separator air outlet 62, causing poor exhaust. This leads to steam being discharged together with water flow from the water vapor separator water outlet 61, resulting in flow interruption and steam sputtering. When the cross-sectional area of the water vapor separator air outlet 62 is greater than or equal to 22 mm2, this situation can be avoided.

In some embodiments, a cross-sectional area of the first connection port 642 is greater than or equal to 22 mm2. This may prevent forming a water film due to an excessively small cross-sectional area when water flows out of a first-stage water vapor separation cavity K through the first connection port 642 to cause poor water drainage.

An operation process of a water cutoff operation of the water vapor separator 60 is described below as shown in FIG. 28.

In FIG. 28, the water cutoff process of the water vapor separator is divided into six states.

State (a) is a water level state during water production.

State (b) corresponds to the moment when water taking stops. Water flowing out from the first-stage water vapor separation cavity K may rush out of the third guide tube 655 due to water flow inertia and water adhesion characteristics. This causes the water level inside the third guide tube 655 to be lower than the water level inside the retention groove N when the retention groove N is filled with water.

State (c) is a state where, as time increases, water in the third guide tube 655 gradually stabilizes. A portion of water in the retention groove N returns to the third guide tube 655, causing the water level inside the third guide tube 655 to equalize with the water level inside the retention groove N. Consequently, the water level inside the retention groove N is lower than a top end portion of the stop wall 654.

In state (d), if residual water droplets in the first-stage water vapor separation cavity K fall into the second-stage water vapor separation body 65, the water level inside the retention groove N and the water level inside the third guide tube 655 rise correspondingly. However, due to water viscosity, water adheres to a side of the stop wall 654 close to the retention groove N, i.e., water in the retention groove N may not cross over the stop wall 654. Therefore, no water droplets fall from the water vapor separator water outlet 61. In this way, a rapid water sealing effect is achieved when water taking stops.

State (e) corresponds to a schematic diagram where the stop wall 654 blocks dripping water within the retention groove.

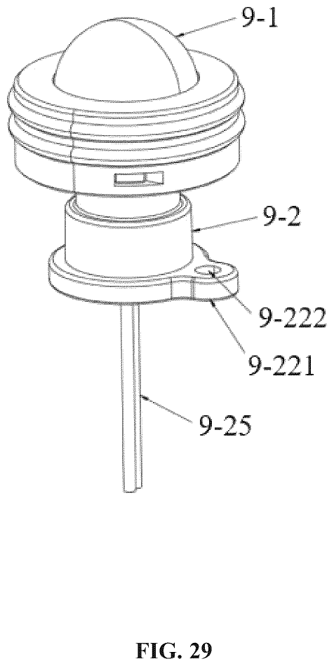

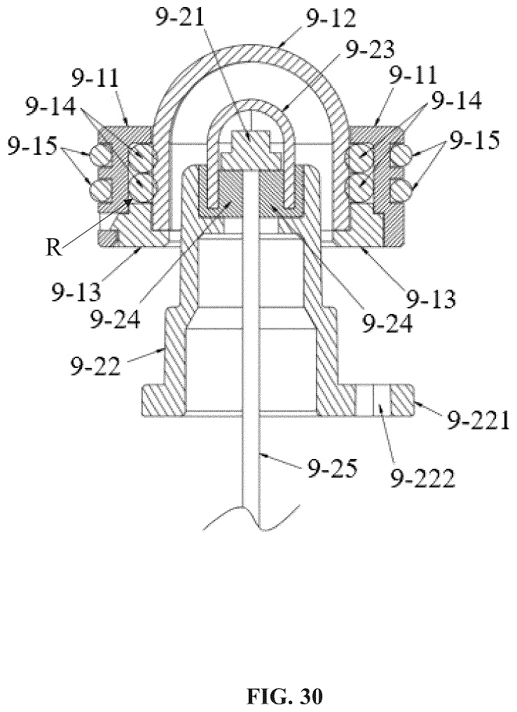

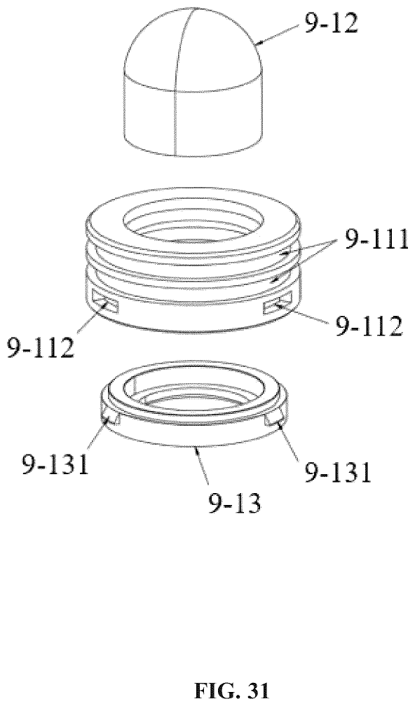

FIG. 29 is a schematic diagram illustrating an overall structure of a split-type UV sterilization module according to some embodiments of the present disclosure. FIG. 30 is a cross-sectional view illustrating an overall structure of a split-type UV sterilization module according to some embodiments of the present disclosure. FIG. 31 is a schematic diagram illustrating structures of a fixing ring, an outer cover, and a bottom cover of a split-type UV sterilization module according to some embodiments of the present disclosure.

As shown in FIGS. 29-31, a split-type UV sterilization module is provided. The split-type UV sterilization module may be used in combination with the water purifier 100 described above, replacing the original sterilization unit 90 of the water purifier 100. The split-type UV sterilization module includes a lamp cover module 9-1 and a sterilization module 9-2.

The lamp cover module 9-1 includes a fixing ring 9-11, a transparent outer cover 9-12, a bottom cover 9-13, at least one first sealing ring 9-14, and at least one second sealing ring 9-15. A material of the transparent outer cover 9-12 is quartz glass. The fixing ring 9-11 sleeves an outer side surface of the transparent outer cover 9-12. The bottom cover 9-13 is disposed on a lower end between the fixing ring 9-11 and the transparent outer cover 9-12. The at least one first sealing ring 9-14 is fixedly disposed between the fixing ring 9-11 and the transparent outer cover 9-12. The at least one second sealing ring 9-15 is located on an outer side surface of the fixing ring 9-11.

The lamp cover module 9-1 refers to an integrated module composed of a transparent cover for mounting and protecting the sterilization module 9-2 and its fixing and sealing components.

The fixing ring 9-11 refers to a connection base for mounting the lamp cover module 9-1 to the purified water tank. For example, the fixing ring 9-11 may be an annular steel ring that is inserted and fixed in the first mounting groove 29 on a side wall of the purified water tank 20 described above. The fixing ring 9-11 provides a mounting foundation and support for the at least one first sealing ring 9-14 and the at least one second sealing ring 9-15.

The fixing ring 9-11 may be the same as or similar to the first locating member 93 described above.

The outer side surface of the fixing ring 9-11 refers to an outer side surface of the fixing ring 9-11 that is away from a central hole of the fixing ring 9-11 along a radial direction of the fixing ring 9-11.

The outer cover 9-12 refers to a cover disposed inside the fixing ring 9-11 for accommodating and protecting the sterilization module 9-2. For example, the outer cover 9-12 may be a tubular structure, one end of the outer cover 9-12 is closed (which may be referred to as a head), and the other end of the outer cover 9-12 has an opening. At least a portion of the sterilization module 9-2 is located in an accommodation space enclosed by a housing of the outer cover 9-12. Sterilization light emitted by the sterilization module 9-2 may penetrate through the outer cover 9-12 to irradiate and sterilize water stored in the purified water tank.

The outer side surface of the outer cover 9-12 refers to an outer side surface of the housing of the outer cover 9-12 that is away from the accommodation space of the outer cover 9-12.

The outer cover 9-12 may be the same as or similar to the lamp cover 91 described above.

The fixing ring 9-11 and the outer side surface of the outer cover 9-12 define a semi-open annular mounting space R. The at least one first sealing ring 9-14 is mounted in the annular mounting space R. The annular mounting space R has an opening end. The bottom cover 9-13 covers the opening end of the annular mounting space R. The annular mounting space R is the same as or similar to the annular mounting space J described above.

The lower end between the fixing ring 9-11 and the outer cover 9-12 is the opening end of the annular mounting space R enclosed by the fixing ring 9-11 and the outer cover 9-12.

The bottom cover 9-13 refers to a structure that closes the opening end of the annular mounting space R to axially (the axial direction of the fixing ring 9-11) limit the at least one first sealing ring 9-14 mounted in the annular mounting space R. For example, the bottom cover 9-13 may be an annular cover plate and configured to cover the opening end of the annular mounting space J to prevent the at least one first sealing ring 9-14 from disengaging from the opening end of the annular mounting space R.

The bottom cover 9-13 may be the same as or similar to the sealing member 97 described above.

The at least one first sealing ring 9-14 may be the same as or similar to the at least one second sealing ring 95 described above. The at least one second sealing ring 9-15 may be the same as or similar to the at least one first sealing ring 94 described above.

In some embodiments, the at least one first sealing ring 9-14 is fixedly disposed between the fixing ring 9-11 and the outer cover 9-12 (i.e., the annular mounting space R) by interference fitting.

The sterilization module 9-2 refers to a module configured to implement a sterilization function.

The fixing base 9-22 refers to a housing or bracket configured to carry, fix, and protect the UV lamp 9-21 and other internal components of the sterilization module 9-2.

In practical application, first, a mounting hole is drilled at a corresponding position on a purified water tank (e.g., a side wall of a housing of the purified water tank 20 described above). The fixing ring 9-11 fixedly penetrates through the mounting hole on the purified water tank, and sealing between the fixing ring 9-11 and the purified water tank is achieved through the at least one second sealing ring 9-15. Next, the transparent outer cover 9-12 is inserted into a center of the fixing ring 9-11, and sealing between the fixing ring 9-11 and the transparent outer cover 9-12 is achieved through the at least one first sealing ring 9-14. Finally, the bottom cover 9-13 is placed between the fixing ring 9-11 and the transparent outer cover 9-12.

The outer cover 9-12 is transparent, and the UV lamp 9-21 extends into the interior of the outer cover 9-12. When the UV lamp 9-21 operates, ultraviolet light emitted by the UV lamp 9-21 penetrates through the outer cover 9-12 and irradiates into an interior of the purified water tank, thereby achieving the sterilization effect on water in the purified water tank.

Components of the split-type UV sterilization module do not occupy a space or a path for closing the water tank cover, and do not affect covering of the water tank cover. Wires (e.g., lead wires 9-25 described below), connectors, and fixing structures of the split-type UV sterilization module are all located outside the purified water tank, which does not affect aesthetics of the purified water tank.

In some embodiments, a material of the outer cover 9-12 includes quartz glass, acrylic, or the like. For example, the material of the outer cover 9-12 is quartz glass.

Quartz glass has a high ultraviolet transmittance, which can effectively ensure sterilization capability of the UV lamp.

In some embodiments, a side surface of the fixing ring 9-11 is provided with a buckle slot 9-112. An outer side of the bottom cover 9-13 is fixedly provided with a clamping block 9-131. The clamping block 9-131 is clamped in the buckle slot 9-112.

For example, the buckle slot 9-112 may be a through slot provided on the side surface of the fixing ring 9-11 and penetrating through the fixing ring 9-11.

The clamping block 9-131 may be a protruding structure disposed on the outer side of the bottom cover 9-13. A shape of the clamping block 9-131 is adapted to a shape of the buckle slot 9-112, so that the clamping block 9-131 can be clamped in the buckle slot 9-112.

The outer side of the bottom cover 9-13 refers to an outer side surface of the bottom cover 9-13 that is away from a central hole of the bottom cover 9-13 along a radial direction of the bottom cover 9-13. When the bottom cover 9-13 covers the lower end between the fixing ring 9-11 and the outer cover 9-12, the clamping block 9-131 is clamped into the buckle slot 9-112 from an inner side of the fixing ring 9-11.

By providing the buckle slot 9-112 and the clamping block 9-131, the lamp cover module 9-1 as a whole may be fixedly disposed on the purified water tank.

In some embodiments, the outer side surface of the fixing ring 9-11 is circumferentially provided with a sealing groove 9-111, and the at least one second sealing ring 9-15 is located in the sealing groove 9-111.

The term “circumferentially” refers to the at least one sealing groove 9-111 encircling the outer side surface of the fixing ring 9-11 for one full circle, forming a complete ring.

In the present embodiment, by providing the at least one sealing groove 9-111 for mounting the at least one second sealing ring 9-15, axial movement of the at least one second sealing ring 9-15 relative to the fixing ring 9-11 can be avoided. The sealing groove 9-111 may be the same as or similar to the second mounting groove 932 described above.

In some embodiments, a count of the at least one second sealing ring 9-15 is at least two, and a count of the at least one sealing groove 9-111 is at least two. Each of the at least two second sealing rings 9-15 is disposed in the at least two sealing grooves 9-111.

In some embodiments, the sterilization module 9-2 includes an inner cover 9-23 and an inner silicone base 9-24. The inner cover 9-23 is fixedly disposed on the fixing base 9-22, and an end of the inner cover 9-23 close to the fixing base 9-22 is provided with an opening. The UV lamp 9-21 is located inside the inner cover 9-23. The inner silicone base 9-24 is fixedly disposed at the opening.

The inner cover 9-23 refers to a transparent cover body fixed on the fixing base 9-22 and is configured to accommodate and protect the UV lamp 9-21. For example, the inner cover 9-23 may be a tubular structure. One end of the inner cover 9-23 is closed. The other end of the inner cover 9-23 has an opening and is fixed with an inner silicone base 9-24. The UV lamp 9-21 is located in a cavity of the inner cover 9-23. Sterilization light emitted by the UV lamp 9-21 may penetrates through the inner cover 9-23 and the outer cover 9-12 to irradiate and sterilize water stored in the purified water tank.

In some embodiments, a material of the inner cover 9-23 may be the same as or similar to a material of the outer cover 9-12.

The inner silicone base 9-24 refers to an elastic base made of silicone and is configured to be sealingly connected with the inner cover 9-23 and to mount the UV lamp 9-21.

In some embodiments, the inner silicone base 9-24 may be fixed to the fixing base 9-22 by bonding, screw connection, resin potting, or the like. The inner silicone base 9-24 is provided with an insertion slot. The other end of the inner cover 9-23 is embedded in the insertion slot, is sealingly connected with the inner silicone base 9-24, and is fixedly disposed on the fixing base 9-22.

The inner cover 9-23 accommodates and protects the UV lamp 9-21, thereby preventing damaging. By providing the inner silicone base 9-24, overall movement of the split-type UV sterilization module can be buffered, impact on the UV lamp 9-21 can be reduced, and the service life can be extended.

In some embodiments, the sterilization module 9-2 further includes a lead wire 9-25. The lead wire 9-25 penetrates through the fixing base 9-22 and the inner silicone base 9-24 in sequence, and is electrically connected to the UV lamp 9-21.

Since the sterilization module 9-2 as a whole is disposed outside the purified water tank, the lead wire 9-25 is arranged from the exterior of the purified water tank. This may not affect the aesthetic appearance of the purified water tank. Compared with traditional technology where excessive and long tubes or wires are suspended inside the purified water tank, the split-type UV sterilization module provided by the present disclosure achieves the purpose of not affecting the aesthetic appearance of the purified water tank.

In some embodiments, an interior of the fixing base 9-22 is filled with resin. For example, the fixing base 9-22 is a hollow structure and is filled with resin. The inner silicone base 9-24 is located at one end of the fixing base 9-22. The lead wire 9-25 penetrates through the fixing base 9-22 and the inner silicone base 9-24 and is electrically connected to the UV lamp 9-21. After the resin solidifies, the lead wire 9-25 is fixed in the interior of the fixing base 9-22. Meanwhile, the inner cover 9-23, the inner silicone base 9-24, and the fixing base 9-22 are fixed as an integral unit.

Resin potting eliminates tiny gaps and potential movement between components, thereby providing protection against vibration and moisture, and ensuring long-term stability.

In some embodiments, the fixing base 9-22 is fixedly provided with a hanging lug 9-221. The hanging lug 9-221 is provided with a through hole 9-222. The sterilization module 9-2 may be fixedly disposed on equipment outside the purified water tank through the hanging lug 9-221, thereby achieving split-type installation of the lamp cover module 9-1 and the sterilization module 9-2.

An operation principle of the split-type UV sterilization module in the embodiment is as follows. In practical application, first, the mounting hole is drilled at the corresponding position on the purified water tank. The fixing ring 9-11 fixedly penetrates through the mounting hole on the purified water tank, and sealing between the fixing ring 9-11 and the purified water tank is achieved through the second sealing ring 9-15. Next, the transparent outer cover 9-12 is inserted into the center of the fixing ring 9-11, and sealing between the fixing ring 9-11 and the transparent outer cover 9-12 is achieved through the first sealing ring 9-14. Finally, the bottom cover 9-13 is placed between the fixing ring 9-11 and the transparent outer cover 9-12, and the clamping block 9-131 on the bottom cover 9-13 is clamped in the buckle slot 9-112. Thus, the lamp cover module 9-1 as a whole is fixedly disposed on the purified water tank. Then, the inner cover 9-23 extends into the transparent outer cover 9-12, thereby causing the UV lamp 9-21 to extend into the interior of the transparent outer cover 9-12. When the UV lamp 9-21 operates, ultraviolet light emitted by the UV lamp 9-21 penetrates through the transparent outer cover 9-12 and irradiates into the interior of the purified water tank, thereby providing the sterilization effect on water in the purified water tank.

Technical features of the above embodiments may be combined arbitrarily. For the sake of concise description, not all possible combinations of the various technical features in the above embodiments are described. However, as long as the combinations of these technical features have no contradiction, the combinations should be considered as within the scope recorded in the present disclosure. The above embodiments only express several implementations of the present disclosure. The description is relatively specific and detailed, but should not be construed as limiting the scope of the present disclosure. It should be pointed out that, for those having ordinary skills in the art, several variations and improvements may be made without departing from the concept of the present disclosure. These variations and improvements all fall within the protection scope of the present disclosure. Therefore, the protection scope of the present disclosure should be subject to the appended claims.

What is claimed is:

1. A water purifier, comprising:
a housing;
a purified water tank detachably disposed on an outer side of the housing, wherein the purified water tank is provided with a purified water tank communication port and a first mounting groove, the purified water tank communication port is configured to communicate with a purified water supply interface of the water purifier, and a bottom wall of the first mounting groove is provided with a first mounting port; and
a sterilization unit, comprising a lamp cover, a lamp cover locating assembly, and a sterilization lamp, wherein the lamp cover locating assembly includes a first locating member, which is annular in shape, one or more first sealing rings, and one or more second sealing rings; the lamp cover is located in the first mounting groove, and a head of the lamp cover is exposed into the purified water tank through the first mounting port; the first locating member sleeves an outer peripheral side of the lamp cover; the one or more first sealing rings are sealingly disposed between the first locating member and a side groove wall of the first mounting groove; and the one or more second sealing ring are sealingly disposed between the first locating member and the outer peripheral side of the lamp cover;
wherein the sterilization lamp is disposed on an outer wall of the housing such that, when the purified water tank is mounted on the outer side of the housing, the sterilization lamp extends into an inner side of the lamp cover.

2. The water purifier according to claim 1, wherein the lamp cover locating assembly further includes a sealing member, the sealing member is connected to an end portion of the first locating member facing the purified water tank and abuts against a side of the one or more second sealing rings facing the purified water tank.

3. The water purifier according to claim 2, wherein the sealing member is provided with a clamping arm, the first locating member is provided with a clamping slot, and the clamping arm and the clamping slot are engaged with each other.

4. The water purifier according to claim 3, wherein an end portion of the sealing member along an axial direction of the first locating member is provided with a first abutting portion and a second abutting portion, which are annular in shape; the first abutting portion is configured to abut against the one or more second sealing rings; and the second abutting portion is configured to abut against an end portion of the lamp cover facing the purified water tank.

5. The water purifier according to claim 1, wherein a count of the one or more first sealing rings is at least two, and the at least two first sealing rings are arranged along an axial direction of the first locating member; and/or
a count of the one or more second sealing rings is at least two, and the at least two second sealing rings are arranged along the axial direction of the first locating member.

6. The water purifier according to claim 5, wherein an outer peripheral surface of the first locating member is provided with at least two second mounting grooves, which are annular in shape, and each of the at least two first sealing rings is disposed in the at least two second mounting grooves;
an inner peripheral surface of the first locating member is provided with at least one annular stop portion; the at least one annular stop portion and an inner peripheral side of the first locating member define a mounting space (J), which is annular and semi-open; and the at least two second sealing rings are disposed in the mounting space (J).

7. The water purifier according to claim 1, wherein the sterilization lamp includes a sterilization lamp mounting bracket and a lamp body; the sterilization lamp mounting bracket is disposed at a position on the outer wall of the housing corresponding to the first mounting port; and the lamp body is disposed at an end portion of the sterilization lamp mounting bracket facing the purified water tank;
the housing is provided with a second mounting port, and the sterilization lamp mounting bracket penetrates through the second mounting port and extends out of the housing.

8. The water purifier according to claim 1, both the first mounting port and the purified water tank communication port are located between a top and a bottom of the purified water tank, and a setting position of the first mounting port is higher than a setting position of the purified water tank communication port.

9. The water purifier according to claim 1, wherein the water purifier further comprises a filter, an exhaust member, a communicating vessel, and a liquid level box;
the exhaust member is provided with a first chamber in communication with atmosphere, and the first chamber communicates with a filter liquid outlet of the filter;
the purified water tank and the liquid level box communicate with the atmosphere, and the liquid level box is internally provided with a water level sensor for detecting a water level;
the communicating vessel is provided with a communicating vessel inner cavity, and the communicating vessel inner cavity communicates with the purified water tank, the liquid level box, and the first chamber, respectively;
water filtered by the filter is capable of being input into the exhaust member and the communicating vessel in sequence, and flowing into the liquid level box and the purified water tank through the communicating vessel inner cavity.

10. The water purifier according to claim 9, wherein the exhaust member is disposed on an outer side wall of the liquid level box, and opposing side walls of the exhaust member and the liquid level box are both provided with communication ports that communicate with each other to allow the first chamber to communicate with a liquid level box inner cavity of the liquid level box;
the water level sensor is configured as a float sensor, and the water level sensor includes a first float and a second float;
in a height direction of the liquid level box inside the liquid level box, a first upper baffle, a first lower baffle, a second upper baffle, and a second lower baffle are provided in sequence, the first float is located between the first upper baffle and the first lower baffle, and the second float is located between the second upper baffle and the second lower baffle;
the water level sensor is configured to be capable of detecting a liquid level in the liquid level box; when the first float abuts against the first upper baffle, the liquid level is determined to be at a high liquid level; and when the second float abuts against the second lower baffle, the liquid level is determined to be at a low liquid level;
the filter includes a filter housing and a filter body; the filter housing is provided with a filter inner cavity with an open end, and the filter body is disposed in the filter inner cavity; and
the liquid level box communicates with the filter inner cavity of the filter through a third pipeline.

11. The water purifier according to claim 9, wherein the liquid level box is provided with a liquid level box communication port;
a volume of a purified water tank inner cavity of the purified water tank is greater than a volume of the liquid level box inner cavity of the liquid level box;
a minimum cross-sectional area of a first communication channel for communicating the purified water tank communication port with the communicating vessel inner cavity is greater than a minimum cross-sectional area of a second communication channel for communicating the liquid level box communication port with the communicating vessel inner cavity.

12. The water purifier according to claim 11, wherein the cross-sectional area S1 of the purified water tank inner cavity along the height direction of the water purifier and the cross-sectional area S3 of the liquid level box inner cavity along the height direction of the water purifier satisfy: S1>S3;
a bottom wall of the purified water tank inner cavity is configured to be flush with a bottom wall of the liquid level box inner cavity;
the communicating vessel is disposed in the housing and provided with the communicating vessel inner cavity that communicates with the purified water supply interface in the water purifier, the communicating vessel is provided with a communicating vessel connection tube that communicates with the communicating vessel inner cavity; an inner wall of the communicating vessel connection tube is provided with a sealing ring; two axial ends of the sealing ring abut against the inner wall of the communicating vessel connection tube;
the purified water tank is provided with a purified water tank connection tube; the purified water tank connection tube communicates with the purified water tank inner cavity of the purified water tank and is disposed at a position corresponding to the purified water tank communication port; the purified water tank connection tube is configured to be capable of being inserted into the communicating vessel connection tube to enable communication between the communicating vessel inner cavity and the purified water tank inner cavity;
an inner peripheral surface of the first sealing section between the two axial ends of the sealing ring is convexly provided with at least two interference fit portions, which are annular in shape; the at least two interference fit portions are arranged at intervals along an axial direction of the sealing ring; and the at least two interference fit portions are configured to be in interference fit with the purified water tank connection tube;
a count of the at least two interference fit portions is two, and a support protrusion is provided between regions on an outer peripheral surface of the sealing ring corresponding to the two interference fit portions; and
the outer wall of the housing is provided with a supporting member, and the purified water tank is detachably disposed on the supporting member.

13. A split-type UV sterilization module, comprising: a lamp cover module and a sterilization module, wherein the lamp cover module includes a fixing ring, a transparent outer cover, a bottom cover, at least one first sealing ring and at least one second sealing ring, the fixing ring sleeves an outer side surface of the transparent outer cover, the bottom cover is disposed on a lower end between the fixing ring and the transparent outer cover, the first sealing ring is fixedly disposed between the fixing ring and the transparent outer cover, and the second sealing ring is located on an outer side surface of the fixing ring; and
the sterilization module includes a UV lamp and a fixing base, the UV lamp is fixedly disposed on the fixing base, and the UV lamp extends into an interior of the transparent outer cover.

14. The split-type UV sterilization module according to claim 13, wherein a material of the transparent outer cover is quartz glass.

15. The split-type UV sterilization module according to claim 13, wherein a side surface of the fixing ring is provided with a buckle slot, an outer side of the bottom cover is fixedly provided with a clamping block, and the clamping block is clamped in the buckle slot.

16. The split-type UV sterilization module according to claim 13, wherein an outer side surface of the fixing ring is circumferentially provided with at least one sealing groove, and the at least one second sealing ring is located in the at least one sealing groove.

17. The split-type UV sterilization module according to claim 13, wherein the sterilization module further includes an inner cover and an inner silicone base, wherein the inner cover is fixedly disposed on the fixing base, an end of the inner cover close to the fixing base is provided with an opening, the UV lamp is located inside the inner cover, and the inner silicone base is fixedly disposed at the opening.

18. The split-type UV sterilization module according to claim 17, wherein the sterilization module further includes a lead wire, the lead wire penetrates through the fixing base and the inner silicone base in sequence, and is electrically connected to the UV lamp.

19. The split-type UV sterilization module according to claim 13, wherein an interior of the fixing base is filled with resin.

20. The split-type UV sterilization module according to claim 13, wherein the fixing base is fixedly provided with a hanging lug, and the hanging lug is provided with a through hole.
